(19) United States
(12) Patent Application Publication
(10) Pub. No.: US 2012/0219747 A1
(43) Pub. Date: Aug. 30, 2012

(54) PANEL WITH DECORATIVE SLATE

(76) Inventor: Shigeki Kanao, Nishinomiya-shi (JP)

(21) Appl. No.: 13/502,428

(22) PCT Filed: Nov. 11, 2010
(86) PCT No.: PCT/JP2010/070124

§ 371 Date: May 14, 2012

(30) Foreign Application Priority Data
Nov. 13, 2009 (JP) 2009-260487

(51) Int. Cl. B32B 3/26; B32B 3/02; B32B 13/12

(52) U.S. Cl. 428/71; 428/312.4; 428/192

(57) ABSTRACT

Disclosed is a panel with decorative slate that has the appearance of stone, is lightweight and inexpensive, is not prone to staining, and maintains a beautiful appearance over a long period. In the panel with decorative slate, a foam cement panel 41A is joined to the entire back surface of a plate-form stone material 31, wherein the foam cement panel 41A is configured from a laminate structure comprising a porous panel body 2 made from foam cement, and a surface reinforcing layer 43A coated on the surface of the panel body. The panel body 2 contains reinforcing fibers in a dispersed state inside the foam cement; the surface reinforcing layer 43A has a synthetic resin layer embedding a fiber aggregate and is at least disposed between the plate-form stone material 31 and the panel body 2.

### TECHNICAL FIELD

The present invention relates to a panel with decorative slate to be used for exterior walls and interior walls as well as floor materials of various kinds of buildings, constructions, etc.

### BACKGROUND ART

Stone materials such as marble and granite stone are sometimes to be used as decorative panels for heightening decorativeness for exterior walls and interior walls and also floor materials and pillar materials of buildings or the like. However, a decorative panel comprising only a stone material is heavy and therefore, it has been desired to make the decorative panel lightweight in order to improve the transportability at the time of construction and lessen a load on a building to be a support.

Therefore, as a decorative panel made lightweight, a panel obtained by cutting a thin plate out of a stone material, using it as a plate-form stone material, and sticking an aluminum substrate with a honeycomb structure to its back surface has been proposed (e.g., see FIG. 3(e) of Patent Document 1). Further, a method of sticking a substrate to both surfaces of a plate-form stone material and then thinly slicing the stone material into two plates has also been known.

Further, conventionally known techniques disclosed in Patent Documents 2 and 3 are based on the application by the applicant of the present invention and these techniques will be described later.

### PRIOR ART DOCUMENTS

### Patent Documents

PATENT DOCUMENT 1: Japanese Patent Application Laid-Open No. Hei 6-294195
PATENT DOCUMENT 2: Japanese Patent Application Laid-Open No. 2009-74344
PATENT DOCUMENT 3: Japanese Patent Application Laid-Open No. 2009-74345

### SUMMARY OF THE INVENTION

### Problems to be Solved by the Invention

As described above, a decorative panel obtained by sticking an aluminum substrate with a honeycomb structure to a plate-form stone material is made lightweight as compared with a decorative panel comprising a single substance of a stone material. However, since the aluminum substrate is costly, the decorative panel using the substrate is also costly.

Further, since the substrate has a honeycomb structure, rainwater or the like infiltrates through the spaces of the honeycomb in some cases, and further, dew formation sometimes occurs in the spaces of the honeycomb due to the temperature difference between the outer surface and the inner surface of the decorative panel.

Moreover, a stone material weak to water, such as marble, has a problem of stains when being exposed to water for a long period of time, and when water adheres to the back surface of a plate-form stone material due to rainwater infiltration or dew formation as described above, the plate-form stone material absorbs the water and dirt comes up to the surface side or stains are formed in some cases. Incidentally, a stone material with high water absorption coefficient among various kinds of stone materials noticeably causes a problem of the above-mentioned stains, cold cracking, etc.

Additionally, water coming up to the surface of the plate-form stone material can be wiped off to prevent the stains from being generated. However, water adhering to the back surface of the plate-form stone material cannot be removed and actually, generation of stains described above cannot be prevented completely.

The present invention aims to provide a panel with decorative slate which is lightweight, economical, and capable of maintaining beautiful external appearance for a long period of time while suppressing generation of stains.

### Solutions to the Problems

In accordance with the present invention, a panel with decorative slate having a foam cement panel joined to the entire back side surface of a plate-form stone material, wherein

the foam cement panel is constituted by a laminated structure of a porous panel body comprising foam cement and a surface reinforcing layer coated on the surface of the panel body,

the panel body contains reinforcing fibers in the foam cement in a dispersed state, and

the surface reinforcing layer has a synthetic resin layer containing a fiber aggregate embedded therein and disposed at least between the plate-form stone material and the panel body.

There is a fear that the above-mentioned surface reinforcing layer in which glass fibers are used as the above-mentioned fiber aggregate forms an infiltration and transfer channel of water due to insufficient affinity of a synthetic resin and the glass fibers; however, unexpectedly, the above-mentioned surface reinforcing layer exhibits good water-proofness.

A panel with decorative slate obtained by joining a foam cement panel having the surface reinforcing layer to the back surface of a plate-form stone material can prevent water from infiltrating to the plate-form stone material from the foam cement panel and water adhesion to the plate-form stone material.

According to the panel with decorative slate of the present invention, since the above-mentioned panel body is a porous molded body, the specific gravity is low and the panel with decorative slate obtained by joining the foam cement panel to a plate-form stone material can be made lightweight.

Since the surface reinforcing layer is joined to the entire back surface of the plate-form stone material, even if water infiltrates the panel body, the water does not infiltrate the plate-form stone material and is inhibited by the surface reinforcing layer. That is, the surface reinforcing layer serves as a water-proofing layer.

The above-mentioned surface reinforcing layer is formed by embedding a fiber aggregate in a synthetic resin and has unevenness in the surface. In the case of joining a foam cement panel and a plate-form stone material with an adhesive or the like, the unevenness exhibits an anchor effect. Thereby the adhesive property is improved and troubles of separation and dropping of the plate-form stone material due to impact or vibration can be prevented.

In addition, in the case of using a solid stone material for a wall material or the like, water-proofing treatment is carried out for both front and back surfaces of the solid stone and particularly, a water-proofing sheet is stuck to the back surface of that.

However, in the case of the panel with decorative slate obtained by joining a foam cement panel to a plate-form stone material similarly to the present invention, since the surface reinforcing layer of the panel with decorative slate exhibits a water-proofing effect as described above, there is no need to carry out water-proofing treatment for the back surface of the plate-form stone material and it is unnecessary to provide a water-proofing sheet to the back surface of the panel with decorative slate.

Moreover, since the above-mentioned foam cement panel can be produced economically, a panel with decorative slate obtained by joining the foam cement panel to a plate-form stone material can also be produced economically as compared with a decorative panel of a stone material alone.

Patent Documents 2 and 3 described above propose those using mainly panels of foam cement as panels for concrete formwork or the like.

Foam cement is extremely lightweight but insufficiently in the strength. Therefore, Patent Documents 2 and 3 described above performs improvements, for example, by coating both front and back surfaces of a foam cement panel with a surface reinforcing layer that is obtained by embedding a sheet such as a nonwoven fabric of an aggregated short fiber glass mat in a synthetic resin, or by providing a side part reinforcing layer comprising a foamable synthetic resin in the outer circumference of a foam cement panel, based on the necessity. Further, a surface protection layer is provided to give water-proofness, based on the necessity.

In the panel with decorative slate of the present invention, in order to reinforce the foam cement panel to be a substrate, the surface reinforcing layer may be provided on both front and back surfaces of the panel body. Additionally, hereinafter, the surface of the panel body in the side where the plate-form stone material is stuck is sometimes referred to as the front surface and the surface in the reverse side is sometimes referred to as the back surface.

Further, in the above-mentioned foam cement panel, a side surface reinforcing layer can be formed by providing the synthetic resin molded body in which a fiber aggregate is embedded in the side surface of the circumference of the panel body, or thickly applying a sealer.

The above-mentioned side surface reinforcing layer may be constituted by using a non-foam synthetic resin; however, a foamable synthetic resin may be used considering weight saving.

Alternatively, it may also be one obtained by providing a side surface reinforcing layer comprising a synthetic resin alone which does not impregnate a fiber aggregate in the side surface of the circumference of the panel body.

With respect to the panel with decorative slate of the present invention, it is preferable to join the plate-form stone material to the side surface of the outer circumference of the above-mentioned foam cement panel and to dispose the above-mentioned side surface reinforcing layer between the plate-form stone material joined to the side surface and the panel body.

The basic configuration of the panel with decorative slate of the present invention is formed by joining the foam cement panel to the back surface of the plate-form stone material; in other words, it is formed by joining the plate-form stone material to the front surface side of the foam cement panel, and the appearance can be made to be similar to a solid stone material by joining the plate-form stone material to the side surface of the outer circumference of the foam cement panel as described above, and thus the decorativeness is further improved.

If the side surface reinforcing layer is disposed between the plate-form stone material for a side surface and the side surface of the outer circumference of the panel body, infiltration of water to the plate-form stone material for a side surface from the panel body is prevented and generation of stains in the plate-form stone material for a side surface can be prevented.

Further, in the present invention, the above-mentioned plate-form stone material and the above-mentioned foam cement panel can be attached to each other by various kinds of adhesives. Examples of the adhesives include various adhesives such as synthetic resin-based adhesives, epoxy resin-based adhesives, urethane resin-based adhesives, vinyl acetate resin-based adhesives, modified silicone resin-based adhesives, gypsum-based adhesives, and a-cyanoacrylate-based adhesives.

Examples of the synthetic resin for the surface reinforcing layer in the foam cement panel of the present invention include either of a foamable synthetic resin and a non-foam synthetic resin, and a foamable synthetic resin is preferable. It is because more lightweight is made possible.

Additionally, it is confirmed that in the case where the foamable synthetic resin is used for the surface reinforcing layer, good water-proofness can be exerted by experiments. The reason why the water-proofness is not deteriorated is because the foamable synthetic resin has a closed cell structure.

In the present invention, examples of the synthetic resin for the surface reinforcing layer or the side surface reinforcing layer include urethane-based resins such as hard polyurethanes and soft polyurethanes, polystyrene-based resins, polyethylene-based resins, hard vinyl chloride-based resins, urea-based resins, phenolic-based resins, acrylic-based resins, cellulose acetate-based resins, and other resins.

Further, examples of a reinforcing material for the above-mentioned surface reinforcing layer include a woven fabric or a nonwoven fabric as a fiber aggregate [one previously formed into a mat form (a sheet form, a film form, a board form, etc.) by using long fibers or short fibers], and they may be embedded in the above-mentioned synthetic resins (hereinafter, referred to as a mat type).

Further, short fibers cut into a desired length (that is, chopped strands) may be dispersed in the panel body (dispersed short fibers become the fiber aggregate in the present invention) and embedded in the above-mentioned synthetic resins (hereinafter, referred to as a dispersal type).

Additionally, a woven fabric or a nonwoven fabric to be used for the above-mentioned mat type is generally referred to as a surface reinforcing cloth.

Examples of the above-mentioned fiber aggregate include natural or synthetic organic fibers in addition to inorganic fibers represented by glass fibers. Among them, glass fibers are preferable.

With respect to the above-mentioned foam cement panel, the outer circumferential side end part of the laminated structure body comprising the above-mentioned panel body and the surface reinforcing layer may be coated with a film, sheet, board, or the like comprising a non-foam synthetic resin for integration. In addition, hereinafter, the above-mentioned film, sheet, board, or the like formed to the outer circumferential side end part of the laminated structure body as described above is generically referred to as an end part protection layer.

Moreover, the front and back surfaces of the laminated structure body comprising the above-mentioned panel body and the surface reinforcing layer may be further coated with a film; sheet, board, or the like comprising a non-foam synthetic resin for integration. In addition, hereinafter, the above-mentioned film, sheet, board, or the like further formed onto the front and back surfaces of the laminated structure body as described above is generically referred to as a surface protection layer.

Examples of a material used for the above-mentioned surface protection layer include materials which are the same as those used as the material for the above-mentioned surface reinforcing layer. The surface protection layer may be formed successively to or simultaneously with the formation of the surface reinforcing layer and in the case of simultaneous formation, it is preferable to use the same material.

### [Koguchi-Free Foam Cement Panel]

Next, a foam cement panel in a panel with decorative slate will be described.

First, the configuration of a foam cement panel having no side surface reinforcing layer in the outer circumferential side end part of the foam cement panel and having a surface reinforcing layer constituted by a synthetic resin and a fiber aggregate (hereinafter, referred to as Koguchi-free type) on the surface or on the front and back surface of the foam cement panel will be described.

The foam cement panel (Koguchi-free type) is a panel obtained by coating the surface of the above-mentioned foam cement panel with the surface reinforcing layer (layer formed by embedding the fiber aggregate in the synthetic resin).

Specifically, a panel body includes a porous molded body obtained by, for example, filling a cement molding die with a kneaded material of cement, water, reinforcing fibers, and foams prefoamed by a foaming agent and curing and solidifying the kneaded material, and the above-mentioned reinforcing fibers and foams are contained in a dispersed state in the molded body, and the specific gravity is in a range of 0.5 to 1.0.

At the time of molding the panel body, a lightweight aggregate such as Shirasu may be blended.

It is preferable that 1 to 5 parts by mass of the reinforcing fibers are blended based on 100 parts by weight of the cement in the kneaded material and the above-mentioned reinforcing fibers are preferably Vinylon. Further, the fiber length of the reinforcing fiber is preferably in a range of 4 to 35 mm.

With respect to a method for producing a foam cement panel, in the case where the surface reinforcing layer is a mat type, the panel body is arranged in a molding die and a gap between the inner surface of the molding die and the outer surface of the panel body is filled with a foamable synthetic resin so as to embed a surface reinforcing cloth (woven fabric or nonwoven fabric).

After the filling of the foamable synthetic resin, the above-mentioned molding die is closed tightly and the filled foamable synthetic resin is foamed and cured to integrally coat the surface of the above-mentioned panel body with the surface reinforcing layer (synthetic resin in which the surface reinforcing cloth is embedded).

Additionally, the surface reinforcing layer may be a dispersal type containing short fibers in a dispersed state in place of the mat type using the surface reinforcing cloth.

### [Another Foam Cement Panel]

With respect to another foam cement panel having a mat type surface reinforcing layer, a panel body is arranged in a molding die in the state where a film, sheet, or board to be a surface protection layer is stuck to the inner surface of the molding die.

A gap between the inner surface of the above-mentioned surface protection layer and the outer surface of the panel body is filled with a foamable synthetic resin so as to embed a surface reinforcing cloth comprising a woven fabric or a nonwoven fabric.

After the filling, the above-mentioned molding die is closed and the foamable synthetic resin is foamed and cured to integrate the surface reinforcing layer with the surface of the above-mentioned panel body by the foamable synthetic resin in which the above-mentioned surface reinforcing cloth is embedded and at the same time, the film, sheet, or board to be the surface protection layer is attached to the panel body with the foamable synthetic resin interposed therebetween.

### [Method for Producing Foam Cement Panel]

With respect to a method for producing each foam cement panel, as a method for producing the above-mentioned panel body, either one of the following first production method and second production method can be selected.

A first production method is a method of molding one panel body in one molding die by filling a molding die with a kneaded material of cement, water, reinforcing fibers, and foams prefoamed by a foaming agent and curing and solidifying the kneaded material.

A second production method is a method of obtaining a plurality of panel bodies, the method comprising steps of producing a porous molded body by filling a molding die with a kneaded material of cement, water, reinforcing fibers, and foams prefoamed by a foaming agent and curing and solidifying the kneaded material; and slicing the porous molded body, wherein a blockish porous molded body larger than the panel body is molded by the molding die, and the blockish porous molded body is sliced in a prescribed thickness.

Additionally, a step of coating the outer circumferential side end part of the above-mentioned panel body with an end part protection sheet as an end part protection layer may be included.

### [Foam Cement Panel Having Koguchi]

Next, a foam cement panel having a side surface reinforcing layer in the outer circumferential side surface of a panel body (Koguchi type) will be described.

The foam cement panel having Koguchi is a panel having a surface reinforcing layer on the surface (or both front and back surfaces) of the foam cement panel and further a side surface reinforcing layer on the outer circumferential side surface of the foam cement panel.

If a side surface reinforcing cloth comprising a woven fabric or a nonwoven fabric is embedded between the outer circumferential side surface of the above-mentioned panel body and the side surface reinforcing layer, the panel body is provided with increased rigidity against twisting.

In order to suppress increase of production cost and prevent interlayer peeling from being generated, it is preferable to use a nonwoven fabric comprising glass fibers which has a weight per unit area of 50 to 1000 g/m² for such a side surface reinforcing cloth and a fiber aggregate of the above-mentioned surface reinforcing layer. In addition, the above-mentioned side surface reinforcing cloth may be embedded or may not be embedded in accordance with necessity.

In the case where a surface protection layer is provided on both front and back surfaces of the above-mentioned foam cement panel, it is preferable that the outer circumferential end part of the foam cement panel is coated integrally with the above-mentioned side surface protection sheet so that the surface protection layer is not peeled from the outer circumferential rim part of the panel.

Additionally, the panel body can be used in common for the Koguchi type and the Koguchi-free type.

Specifically, the foam cement panel having Koguchi is preferable to have the side surface reinforcing layer comprising the foamable synthetic resin and integrally attached to the outer circumferential side surface of the panel body, the side face reinforcing cloth including a woven fabric or a nonwoven fabric embedded if necessary between the outer circumferential side surface and the side part reinforcing layer of the panel body, and the surface reinforcing layer coated in the state of striding the panel body and the surface of the side surface reinforcing layer (layer formed by embedding the fiber aggregate (e.g., surface reinforcing cloth) in the synthetic resin).

### [Method for Producing Foam Cement Panel Having Koguchi]

In the case of mat type surface reinforcing layer

The bottom part of a molding die which can be tightly closed and has an inner space slightly larger than a foam cement panel is filled with a foamable synthetic resin and at the same time, a surface reinforcing cloth comprising a woven fabric or a nonwoven fabric with approximately the same plane size as the size of the bottom surface of the molding die is embedded in the foamable synthetic resin.

Next, the foam cement panel is positioned in the center of the molding die and the foamable synthetic resin is filled in the outer circumferential side surface and upper surface of the foam cement panel.

A surface reinforcing cloth comprising a woven fabric or a nonwoven fabric with approximately the same plane size as the inner plane size of the molding die is arranged on the upper surface of the foam cement panel and next, in the state where the molding die is closed, the filled foamable synthetic resin is foamed and cured.

The filled foamable synthetic resin is cured so that a side surface reinforcing layer is attached to the outer circumferential side surface of the foam cement panel and the upper surface is coated with the surface reinforcing layer (synthetic resin in which the surface reinforcing cloth is embedded).

Further, in the state where a film, sheet, or board to be a surface protection layer is previously set in the inner surface of the above-mentioned molding die, the outer circumferential side surface of the foam cement panel may be coated with the side surface reinforcing layer and at the same time, the foam cement panel and the side surface reinforcing layer may be coated so as to wrap them with the surface protection layer (foamable synthetic resin in which the surface reinforcing cloth is embeded).

The foamable synthetic resin constituting the surface reinforcing layer has a function of attaching the film, sheet, or board to be a surface protection layer to the above-mentioned foam cement panel. Further, the side surface reinforcing cloth comprising a woven fabric or a nonwoven fabric may be fixed previously in the outer circumferential side surface of the above-mentioned panel body.

Further, although the side surface reinforcing layer includes the foamable synthetic resin (synthetic resin molded body) in the above-mentioned example, it can include a sealer without limitation to the foamable synthetic resin as long as the sealer provides impact resistance and water-proofness to the panel side part.

Specific examples of the above-mentioned sealer include silicon-based, acrylic-based, urethane-based, vinyl acetate-based, vinyl chloride-based, and fluorine-based solution resin emulsions.

Further, the above-mentioned sealer may be blended with granular materials such as calcium carbonate, barium sulfate, silica, talc, alumina, and colloidal silica.

Any one kind of these granular materials may be blended and two or more kinds of the granular materials may also be blended in combination.

Furthermore, based on the necessity, additives such as a dispersant, a leveling agent, a defoaming agent, a curing agent, a coloring pigment, a body pigment, a pigment dispersant, a thickener, an ultraviolet absorbent, a light stabilizer, an anti-freezing agent, and a film formation aid may be blended.

Additionally, the above-mentioned sealer may be applied thickly in a prescribed thickness by various kinds of application means such as a spray, a roller, and a brush. Moreover, in place of the sealer, a coating film having water-proofness and weak elasticity may be formed.

### [Another Method for Producing Foam Cement Panel Having Koguchi]

In the case of a mat type surface reinforcing layer

Producing a blockish porous molded body by filling a formwork with a kneaded material of cement, water, reinforcing fibers, and foams prefoamed by a foaming agent and curing and solidifying the kneaded material;

In a tightly closed molding die, filling a foamable synthetic resin between the outer circumferential surface of the above-mentioned porous molded body and the inner surface of the molding die which is tightly closed and foaming and curing to integrally attach the foamable synthetic resin to the outer circumferential side surface of the porous molded body;

Producing a foam cement panel by slicing the above-mentioned porous molded body attaching the side surface reinforcing layer to the outer circumferential side surface, using a foamed synthetic resin;

Filling a foamable synthetic resin in the bottom part of a tightly closable molding die and at the same time, arranging a surface reinforcing cloth comprising a woven fabric or a nonwoven fabric with approximately the same plane size as the inner plane size of the molding die in the foamable synthetic resin;

Positioning the foam cement panel in the molding die and filling a foamable synthetic resin on the upper surface side of the foam cement panel and at the same time, arranging the surface reinforcing cloth comprising a woven fabric or a nonwoven fabric with approximately the same plane size as the inner plane size of the molding die in the foamable synthetic resin; thereby

In the tightly closed state of the molding die, the foamable synthetic resin filled in the molding die is foamed and cured to coat the surface of the foam cement panel with the surface reinforcing layer (foamable synthetic resin in which the surface reinforcing cloth is embedded).

### [Still Another Method for Producing Foam Cement Panel Having Koguchi]

In the case where a surface reinforcing layer is mat type and has a side surface reinforcing cloth

Producing a blockish porous molded body by filling a formwork with a kneaded material of cement, water, reinforcing fibers, and foams prefoamed by a foaming agent and curing and solidifying the kneaded material;

Temporarily fixing a side surface reinforcing cloth comprising a woven fabric or a nonwoven fabric in the outer circumferential side surface of the porous molded body;

Filling a foamable synthetic resin between the outer circumferential side surface of the above-mentioned porous molded body in which the side surface reinforcing cloth is temporarily fixed and a molding die and integrally attaching the foamable synthetic resin impregnated with the side surface reinforcing cloth to the outer circumferential side surface of the porous molded body;

Producing a foam cement panel with a prescribed thickness by slicing the porous molded body to which the foamed synthetic resin layer is attached using a foamed synthetic resin;

Placing a surface reinforcing cloth comprising a woven fabric or a nonwoven fabric with approximately the same plane size as the inner space of the molding die on the bottom part of the molding die and filling a foamable synthetic resin;

Positioning the foam cement panel in the molding die, placing a surface reinforcing cloth comprising a woven fabric or a nonwoven fabric with approximately the same plane size as the inner plane size of the molding die on the upper surface side of the foam cement panel, and filling a foamable synthetic resin; thereby

The filled foamable synthetic resin is foamed and cured to coat the surface of the foam cement panel with the surface reinforcing layer (foamable synthetic resin in which the surface reinforcing cloth is embedded).

In another method and still another method for producing the foam cement panel having Koguchi, in the step of coating the surface protection layer in the state of striding over the above-mentioned foam cement panel and the side surface reinforcing layer with the surface reinforcing layer, if a film, sheet, or board to be a surface protection layer is previously set in the inner surface of the tightly closable molding die, the surface of the foam cement panel is integrally coated with the surface reinforcing layer (foamable synthetic resin in which the surface reinforcing cloth is embedded) in the molding die and at the same time, the above-mentioned film, sheet, or board to be a surface protection layer can be attached to the foam cement panel with the foamable synthetic resin for forming the surface reinforcing layer interposed therebetween.

In the respective production methods of the foam cement panel having Koguchi, the outer circumferential end parts of the foam cement panel may be coated with an end part protection sheet (an end part protection layer).

Further, in the respective production methods of the foam cement panel having Koguchi, either one of the above-mentioned first and second production methods of a foam cement panel can be selected as a method for producing the panel body.

### Effects of the Invention

According to the panel with decorative slate of the present invention, a foam cement panel is employed so that the panel with decorative slate can be made lightweight and supplied economically.

Further, the present invention provides an effect of preventing stains from being generated on the surface of the plate-form stone material of the panel with decorative slate and maintaining beautiful appearance for a long period of time.

The present invention also provides an advantage that the plate-form stone material and the foam cement panel are reliably joined to each other so that the plate-form stone material is peeled with difficulty.

### BRIEF DESCRIPTION OF THE DRAWINGS

FIG. 1 A cross-sectional view showing a configuration of the first panel with decorative slate of the present invention.

FIG. 2 A cross-sectional view showing a configuration of the second panel with decorative slate of the present invention.

FIG. 3 A cross-sectional view showing a configuration of the third panel with decorative slate of the present invention.

FIG. 4 A cross-sectional view showing a configuration of the Koguchi-free type foam cement panel of the present invention.

FIG. 5 An explanatory view showing another method for producing the foam cement panel shown in FIG. 4.

FIG. 6 A cross-sectional view showing another example of the Koguchi-free type foam cement panel of the present invention.

FIG. 7 A cross-sectional view showing a configuration of the foam cement panel having Koguchi of the present invention.

FIG. 8 An explanatory view showing another method for producing the foam cement panel of the present invention.

FIG. 9 A cross-sectional view showing another configuration of the foam cement panel having Koguchi of the present invention.

FIG. 10 A cross-sectional view showing another configuration of the foam cement panel of the present invention, in which a surface reinforcing layer and a side surface reinforcing layer are provided and further a surface protection layer and an end part protection sheet are provided.

FIG. 11 A cross-sectional view showing another configuration of the foam cement panel having Koguchi of the present invention, in which a surface reinforcing layer is provided and a side face reinforcing cloth is embedded between a foam cement panel and a side surface reinforcing layer.

FIG. 12 A perspective view of a blockish porous molded body in which a side face reinforcing cloth is temporarily fixed in still another method for producing a panel body of the foam cement panel with Koguchi of the present invention.

FIG. 13 A perspective view of a blockish porous molded body in which a side surface reinforcing layer is attached through a side facet reinforcing cloth in still further another configuration shown in FIG. 12.

FIG. 14 A cross-sectional view showing still another configuration of the foam cement a panel having Koguchi of the present invention, in which a surface reinforcing layer is provided and a side face reinforcing cloth is embedded between a foam cement panel and a side surface reinforcing layer.

### MODE FOR CARRYING OUT THE INVENTION

First, a configuration of a foam cement panel to be a substrate of the panel with decorative slate of the present invention will be described, and next a panel with decorative slate produced using the foam cement panel will be described.

1. Configuration of Foam Cement Panel

1.1 First Foam Cement Panel (Koguchi-Free Type)

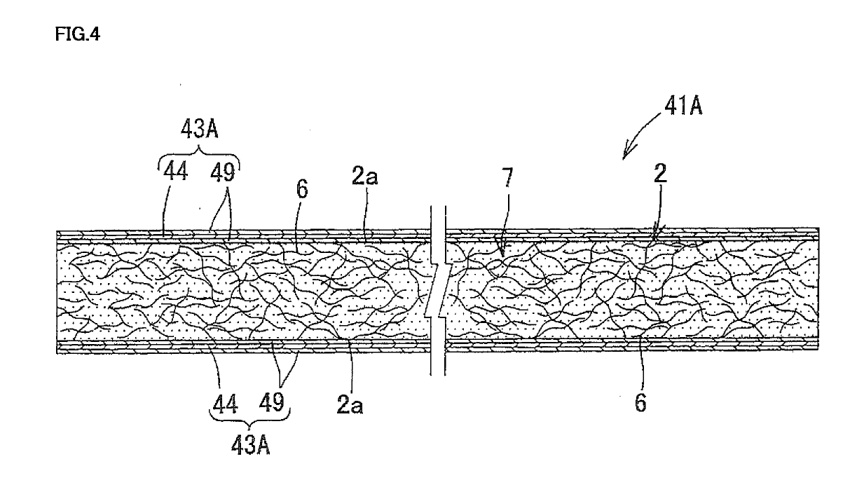

FIG. 4 is a cross-sectional view showing one example of a Koguchi-free type foam cement panel.

A foam cement panel 41A has a foam cement panel 2 obtained by molding foam cement into a panel form, and surface reinforcing layers 43A coating both front and back surfaces 2a of the foam cement panel 2.

Each of these surface reinforcing layers 43A is formed by embedding a surface reinforcing cloth 44 in a synthetic resin 49 and integrally coat the surface of the foam cement panel 2. The surface reinforcing cloth 44 includes a woven fabric or a nonwoven fabric.

The above-mentioned foam cement panel 2 includes reinforcing fibers 6 and a porous molded body 7 containing a large number of foams (not illustrated) in a dispersed state. The porous molded body 7 is obtained by filling a formwork with a kneaded material of cement, water, reinforcing fibers, and foams prefoamed by a foaming agent and curing and solidifying the kneaded material.

The cement is not particularly limited but conventional Portland cement, rapid-hardening Portland cement, super rapid-hardening Portland cement, and other various kinds of cement can be used. Of these, rapid-hardening Portland cement is preferable from the viewpoint of productivity, strength, etc.

The blending ratio of cement to water is preferably a range between 20 and 100 parts by weight of water with respect to 100 parts by weight of cement, and more preferably, a range between 20 and 50 parts by weight of water. An excessively large volume of water tends to lower the strength and an excessively short volume of water tends to lower the fluidity of cement mixture and impede formability at the time of forming.

Examples of the reinforcing fiber 6 include polyvinyl alcohol fiber (Vinylon), polyolefin-based fiber such as polypropylene fiber, polyethylene fiber, etc., aramide fiber, carbon fiber, steel fiber, glass fiber, and others. Of these fibers, Vinylon fiber is preferable, because it provides high durability and at the same time has outstanding affinity to cement. The fiber length of the reinforcing fiber 6 is not particularly limited but is preferable in the range between 4 and 35 mm. When the fiber length of the reinforcing fiber 6 is less than 4 mm, reinforcing effects tend to be insufficient. It is advantageous to have longer fiber length for the reinforcing fiber 6 from the viewpoint of reinforcing effect but on the other hand, as the fiber length increases, there is a case in which the dispersibility lowers and the reinforcing fiber 6 in the molded product is unevenly distributed and the panel strength may be lowered. In addition, there is no particular limitation to thickness of the reinforcing fiber 6 but in general, 10 μm to 100 μm thick is used.

The foam cement panel 2 can achieve a reinforcing structure by entwining of the reinforcing fiber 6 as shown in FIG. 4 only by uniformly dispersing the reinforcing fiber 6 of Vinylon, glass chops, etc. when cement is kneaded. Consequently, in manufacturing the panel, no complicated operation such as positioning operation is required when net reinforcing member and other reinforcing member is embedded, and panels free of variations in strength can be easily fabricated.

The compounding amount of the reinforcing fiber 6 is preferably 0.5 to 5 parts by weight for 100 parts by weight of the cement. When the compounding amount of the reinforcing fiber 6 is small, the reinforcing effect is low, and the panel strength becomes low. The greater the compounding amount of the reinforcing fiber 6, the more advantageous is the panel reinforcing effect, but the excessive compounding amount of the reinforcing fiber 6 degrades dispersibility in the cement mixture and causes the reinforcing fiber 6 to be unevenly distributed, and nonuniform panel strength results, and there is a fear of all the more lowering the panel strength. From this kind of viewpoint, the preferable range of the compounding amount of the reinforcing fiber 6 is 0.5 to 3 parts by weight for 100 parts by weight of cement.

The foaming agent is not particularly limited, but foaming agents for cement and concrete, for example, protein-based, surfactant-based, resin-based, and other publicly known various kind of foaming agents can be used. Furthermore, together with the above-mentioned foaming agent, metal-based foaming agents such as aluminum powder may be used. The addition amount and the method of adding the foaming agent are not particularly limited but in general, the addition amount should be properly adjusted to achieve the target specific gravity for panel of 1.0 or less within the range of 0.1 to 3 parts by weight for 100 parts by weight of cement. The specific gravity of panel is preferably between 0.5 and 1.0, and more preferably between 0.6 and 0.9, and particularly preferably between around 0.7 and 0.8, as is the case with that of wood-based plywood. The smaller the specific gravity, the lighter is the panel weight and more advantageous from the viewpoint of handleability. However, the smaller the specific gravity, the greater is the porosity and the more degraded is the panel strength. On the other hand, the greater the specific gravity, the heavier is the panel and the more degraded is the handleability.

Upon producing foam cement, a water reducing agent may be used properly. Examples of the water reducing agent include, but are not particularly limited to, a naphthalene-based water reducing agent, a sulfonic acid-based water reducing agent, and a polycarboxylic acid-based water reducing agent.

Upon kneading the above-mentioned kneaded mixture of cement, water, reinforcing fibers, and foams prefoamed by a foaming agent, additives, etc, a conventionally known cement mixer, concrete mixer, or the like can be used, however, it is required to evenly carry out kneading without damages on the foams and reinforcing fibers in the kneaded material.

If the foams are damaged at the time of kneading, the size of the foams in the panel becomes uneven after molding and the panel strength may sometimes become uneven. Further, if damaged, the reinforcing fibers are broken and may possibly fail to obtain the aimed reinforcing effect.

The foam cement panel 2 may also be obtained by kneading cement, water, reinforcing fibers and foams; filling a formwork with the kneaded mixture; either molding the mixture into a plate form with a size corresponding to the purpose of use or into a block with a larger size than the size corresponding to the purpose of use; curing the mixture; and then cutting the cured product into a plate form.

In the case where a block is formed, cement milk containing foams is cured by hydration reaction with cement and water to give a lightweight porous molded body in the state where the reinforcing fibers and a large number of foams are dispersed therein.

The thickness of the foam cement panel 2 is generally about 6 to 30 mm.

One example of a specific method for producing the foam cement panel 2 will be described below.

Water and a water reducing agent are mixed with cement and further reinforcing fibers are added thereto and the mixture is kneaded.

On the other hand, air is introduced into a foaming agent to obtain foams by foaming at a prescribed magnification, for example, at a magnification of about 10 to 30 times.

The foams are added to the above-mentioned kneaded material and kneaded. During the kneading, the specific gravity of the kneaded material is properly measured and foams may be further added and kneaded to make the specific gravity close to an aimed value.

This cement kneaded material is filled in a pressure-resistant metal molding die and molded into a plate form with a size of, for example, 600 mm (width)×1800 mm (length)×11 mm (thickness) and then cured and solidified. Accordingly, the foam cement panel 2, which includes the porous molded body 7 of cement being solidified and is reinforced by intertwining with the reinforcing fibers 6 dispersed in the porous molded body 7, as shown in FIG. 4, can be obtained.

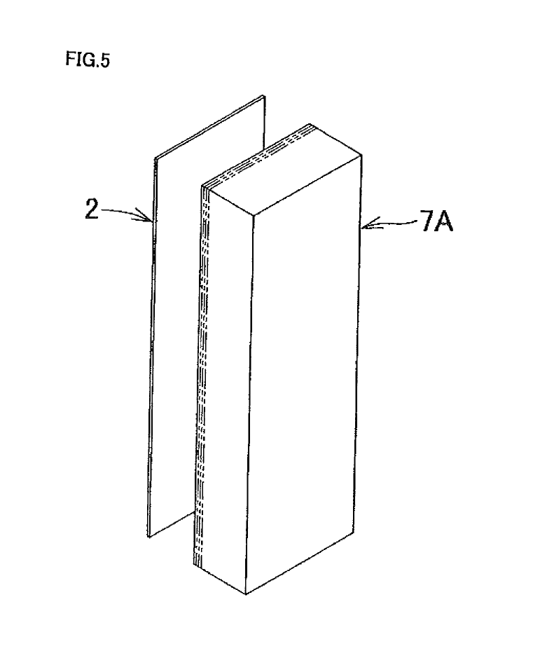

Further, as shown in FIG. 5, a porous molded body 7A with a large size may be molded into a blockish and cured and solidified and thereafter, cut in a plate form with a desired thickness and size.

The curing may be normal curing or steam curing or both may be used in combination. Further, if the curing is carried out by steam curing in the formwork without completion in the formwork and the kneaded material is taken out of the formwork in a stage where solidification is promoted to a certain extent, that is, normally, after several hours, and further cured, the molding cycle in the formwork is shortened and thus the productivity can be improved.

A method of coating the foam cement panel 2 with the surface reinforcing layer 43A is preferably carried out by applying a synthetic resin 49 to the surfaces (front and back surfaces) of the foam cement panel 2, embedding the surface reinforcing cloth 44 in the synthetic resin 49, and attaching the surface reinforcing cloth 44 to the foam cement panel 2 with a foamable synthetic resin as the synthetic resin 49 interposed therebetween.

In this connection, although the synthetic resin 49 and the surface reinforcing cloth 44 are drawn separately in a laminated state in FIG. 4; however, actually the surface reinforcing cloth is impregnated with the synthetic resin to form one layer.

Owing to the surface reinforcing layer 43A including the surface reinforcing cloth 44 and the synthetic resin 49, the strength of the foam cement panel 41A is increased and at the same time, the surface adherability and water-proofness are improved.

In addition, the surface reinforcing layer 43A can be provided to cover both front and back surfaces of the panel body 2; however, generally, the layer may be provided to coat only the back surface 2a in the side on the opposite to the plate-form stone material side.

Examples of the above-mentioned surface reinforcing cloth 44 include woven fabrics and nonwoven fabrics comprising fiber materials such as polyvinyl alcohol fibers (Vinylon), polyolefin-based fibers such as polypropylene fibers and polyethylene fibers, aramide fibers, carbon fibers, steel fibers, and glass fibers.

Further, it is preferable to use a woven fabric or a nonwoven fabric in a mesh form having a large number of relatively large through holes so that the surface reinforcing cloth 44 and the synthetic resin 49 can be integrated.

Particularly, a chopped strand mat comprising glass fibers which has a weight per unit area of 50 to 1000 g/m², preferably 200 to 300 g/m², is made economically available and capable of significantly improving the strength and rigidity of the foam cement panel 41A and therefore it is preferable.

The surface reinforcing cloth 44 may be a cloth capable of being embedded in the synthetic resin 49 and may be arranged not only to the center in the thickness direction of the synthetic resin 49, but also closer to the surface side (plate-form stone material side).

Due to the surface reinforcing layer 43A obtained by embedding the surface reinforcing cloth 44 in the synthetic resin 49, the rigidity against bending and twisting applied to the foam cement panel 41A can be heightened and at the same time, the foam cement panel 2 is reliably protected. Further, the surface of the foam cement panel is made uneven by the surface reinforcing cloth 44 and owing to its anchor effect, adhesion to the plate-form stone material is made better.

The synthetic resin 49 that forms the surface reinforcing layer 43A is not particularly limited, but examples include polystyrene foam, polyethylene foam, hard polyurethane foam, hard vinyl chloride foam, urea foam, phenol foam, acrylic foam, acetylcellulose foam, and other expandable synthetic resins. In addition, it is possible to adopt polystyrene resin, polyethylene resin, hard polyurethane resin, hard polyvinyl chloride resin, urea resin, phenol resin, phenol urethane resin, acrylic resin, acetylcellulose resin, and other nonfoaming synthetic resin.

As a method of molding a foamable synthetic resin, conventionally known molding methods can be employed and, for example, a method of molding the polyurethane foam, the urea foam, the phenol foam, etc., as described above can be employed. As a representative example, methods of foaming these 3 types of foamable resins will be described below.

Polyurethane foam is obtained by polyol, excess diisocyanate, cross-linking agent, foaming agent, catalyst, air-bubble size adjusting agent, and as a foaming agent, carbon dioxide by reactions of water and isocyanate, methylene dichloride, pentane, air injected at the time of mechanical mixing, etc. and organic-based foaming agent of decomposition type are used. For the air-bubble size adjusting agent, silicone resin and emulsifier can be used, and for the catalyst, amines, organic tin compounds can be used.

Further, phenol urethane produced by using dihydric phenol as the polyol may be used. This kind of phenol urethane has characteristics of being extremely excellent in flame retardation.

Urea foam is obtained by dispersing 2 to 30 parts of a foaming agent such as propane, butane, butene, hexane, or methyl chloride in 100 parts of viscous urea-formaldehyde aqueous solution (resin content: 50-90%) of about 1000 cp viscosity in a low-temperature or hermetically sealed container, adding an acid catalyst in the presence of an emulsifier, and then, raising temperature to 15 to 115° C. Additionally, urea resin initial condensate containing an emulsifier may be discharged while mechanically frothing by a site foaming machine with hydrochloric acid liquid being mixed.

Phenol foam is obtained by mixing a curing agent with stirring and allowing it to adhere to the target portion or filling while air is being injected by a foaming machine to the resole initial concentrate to be pureed. Furthermore, foaming may be aided by adding bicarbonate of soda about 1% when the resole initial concentration is pureed. By this method, after the curing agent is added, the concentrate is quickly hardened. For the oxidation catalyst, benzenesulfonic acid, toluenesulfonic acid, sulfonic acid, phosphoric acid, etc. are used. In addition, when a volatile foaming agent is compounded, foam is generated by reaction heat and no initial whipping is required. Phenol resin suited for foaming is commercially available, and tough foam can be fabricated by copolymerizing 85 parts of resole and 5 parts of polyamide obtained from adipic acid and hexamethylenediamine, and toughness, elasticity, etc. may be supplemented by compounding about 5 to 20 parts of polyvinyl alcohol and polyvinyl chloride resin.

Although there is no particular limitation on the foaming magnification of the synthetic resin 49 for the surface reinforcing layer 43A, it is generally about 2 to 10 times.

As the foaming magnification of the synthetic resin 49 is smaller, the panel strength is increased more; however, contrarily, the panel weight is increased. On the other hand, as the foaming magnification of the synthetic resin 49 is larger, the panel becomes more lightweight; however, contrarily, the panel strength is decreased. Accordingly, the foaming magnification of the synthetic resin 49 is properly determined in terms of the transportability, strength, impact resistance, etc. of the panel.

Further, the amount of the synthetic resin 49 to be coated on the panel body 2 is controlled so as to give each thickness of about 0.5 to 2 mm with the surface reinforcing cloth 44 interposed therebetween (in total about 1 to 4 mm), thereby impregnating the surface reinforcing cloth 44.

The synthetic resin 49 for the surface reinforcing layer 43A is preferably a resin having few open cells or a resin having no open cells but having closed cells since they are excellent in water-proofness and surface property.

In a method for producing the above-mentioned foam cement panel 41A, the bottom part of a molding die having an inner space approximately the same size as the plane size of the panel body 2 is filled with the foamable synthetic resin 49 and at the same time, the surface reinforcing cloth 44 with approximately the same plane size as that of the panel body 2 is embedded in the synthetic resin 49.

Next, the panel body 2 is positioned in the molding die and the foamable synthetic resin 49 is filled on the upper surface side of the panel body 2 and at the same time, the surface reinforcingcloth 44 is embedded in the synthetic resin 49.

Successively, in the state where the molding die is closed, the filled synthetic resin 49 is cured to integrally coat the surfaces (front and back surfaces) of the panel body 2 with the surface reinforcing layer 43A comprising the synthetic resin 49 and the surface reinforcing cloth 44.

1.2 Second Foam Cement Panel (Koguchi-Free Type)

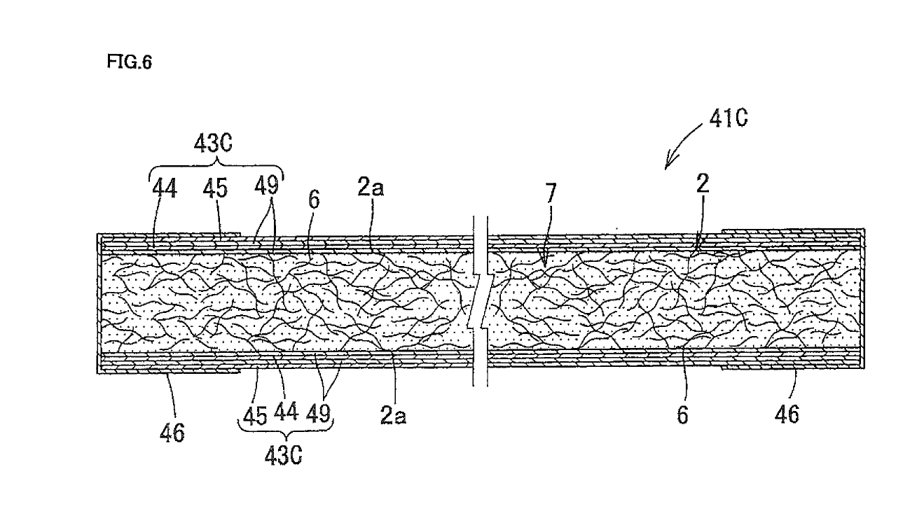

FIG. 6 shows another example of a foam cement panel.

A foam cement panel 41C shown in the same drawing is a panel obtained by coating the outside surface of a surface reinforcing layer (layer in which a surface reinforcing cloth 44 is embedded in a synthetic resin 49) formed on the surfaces (front and back surfaces) of a panel body 2 with a surface protection layer 45 (surface reinforcing layer and surface protection layer are referred to as a surface layer 43C) and coating the outer circumferential side end part of the panel body 2 coated with the surface layer 43C with an end part protection sheet 46.

In FIG. 6, the same symbols are assigned to the configuration elements same as those of FIG. 4, and their descriptions are omitted.

The above-mentioned surface layer 43C is made to have the same size as the plane size of the panel body 2 and the outer circumferential end part of the surface layer 43C is set along the outer circumferential end part of the panel body 2.

The outer circumferential side end part of the panel body 2 having the surface layer 43C is coated with an end part protection sheet 46. Since water infiltration in the panel body 2 from the side surface is prevented by the end part protection sheet 46, the water-proofness and durability of the foam cement panel 41C are further improved.

Further, the end part protection sheet 46 is protected from being peeled from the outer circumferential side end part by the surface layer 43C.

A material of the above-mentioned surface protection layer 45 is not particularly limited and the protection layer may be constituted by, for example, a non-foamable synthetic resin, paper, and paper coated with a non-foamable synthetic resin.

Examples of the non-foamable synthetic resin include polyolefin-based resins such as polyethylene and polypropylene; polyester-based resins such as polyethylene terephthalate; and ABS and MMA.

The adhesion of the surface protection layer 45 and a plate-form stone material to be joined onto the protection layer may be increased by subjecting the surface of a film, sheet, or board comprising a synthetic resin constituting the surface protection layer 45 to corona discharge process or treating the surface thereof with an acid.

The film, sheet, board or paper comprising a synthetic resin constituting the surface protection layer 45 may be monolayer or multilayer.

In the above-mentioned manner, the film, sheet, or board comprising a non-foamable synthetic resin is attached to the outermost layer of the panel body 2, or a synthetic resin is applied to provide the surface protection layer 45 so that the water-proofness can be made more reliable.

The end part protection layer 46 can be formed by any optional method, such as forming by affixing sealing tape with water tightness, forming by bonding or heat-fusing a synthetic resin made film, sheet, or forming by applying synthetic resin to the outer-circumferential end part of the panel proper 2, and others. In addition, synthetic resin frame material with U-letter shape cross-section may be fitted along the side end part of the panel proper 2, fixed by adhesives to form the end part protection layer 6. Preferable examples of synthetic resin that configures the end part protection layer 46 include polyethylene, polypropylene and other polyolefin-based resin, polyethylene terephthalate and other polyester-based resin, ABS, MMA, etc.

The overlapping margin of the end part protection sheet 46 coating the surface layer 43C may be determined properly and it may be, for example, about 3 mm to 10 mm. However, the end part protection sheet 46 may be omitted based on the use conditions, etc.

In a method for producing the foam cement panel 41C, in the same manner as in the case of producing the above-mentioned foam cement panel 41A, in the state where the film, sheet, or board to be the surface protection layer 45 is previously set in the inner surface of the molding die, both front and back surfaces 2a of the panel body 2 are coated with the surface reinforcing layer (layer in which the surface reinforcing cloth 44 is embedded in the synthetic resin 49) and next, a sealing tape having water-tightness is stuck to the outer circumferential side end part of the panel body 2 to form the end part protection sheet 46.

The effect of the above-mentioned foam cement panel (Koguchi-free type) will be described.

The foam cement panel (Koguchi-free type) is lightweight and has highly strength.

Further, unlike a woody plywood using wood resource, the panel uses cement as a main material and therefore, consumption of the wood resource from tropical forests can be saved and it contributes to environmental preservation. Further, as compared with the plywood, the panel has high durability.

Further, since comprising a porous molded body, the panel has a specific gravity of 1.0 or lower, which is as lightweight as the plywood, and is thus excellent in handleability and processibility.

As compared with the plywood, the panel shows less weight increase by water absorption and is thus free from a problem of a decrease in strength with the lapse of time.

Further, since having a configuration reinforced by intertwining with the reinforcing fibers in the dispersed state, the above-mentioned porous molded body is excellent in processibility for nailing or the like while having high strength, and stably keeps the hit nails or the like by the reinforcing fibers existing in the molded body.

Moreover, since the surface of the foam cement panel is coated with the surface reinforcing layer, the bending strength of the foam cement panel is increased and at the same time, the foam cement panel surface is protected. That is, while the lightweight of the foam cement panel is maintained, the strength and impact resistance of the foam cement panel are improved.

Further, water infiltration is prevented by the surface reinforcing layer and the water-proofness of the foam cement panel is improved. For example, a problem such that the weight of the panel is increased by water absorption because of rainfall can be solved.

If a woven fabric or nonwoven fabric comprising glass fibers is used as the above-mentioned surface reinforcing cloth, rise of the production cost of the foam cement panel can be suppressed and the rigidity is sufficiently heightened.

In the foam cement panel (Koguchi-free type), the reinforcing fibers dispersed in the porous molded body are intertwined with each other to form a reinforcing configuration by blending 1 to 5 parts by mass of the reinforcing fibers based on 100 parts by mass of the cement. The above-mentioned reinforcing fibers are preferably of Vinylon, polyvinyl alcohol fibers.

The foam cement panel (Koguchi-free type) may be produced by molding the cement kneaded material into a plate form with an aimed size and also by molding the cement kneaded material into a large size block form and slicing the molded block into a plate form with a desired thickness and size.

In addition, in the case of molding into a block form and slicing the molded block into a plate form, a large number of foam cement panels can be produced by using only a single formwork and curing and solidification can be carried out collectively and thus the productivity is improved.

As described above, if the outer surface of the surface reinforcing layer is coated with the surface protection layer, water absorption from the panel surface is prevented by the surface protection layer and therefore, the water-proofness of the foam cement panel can be further improved.

If the surface protection layer is constituted using a non-foamable synthetic resin, water absorption from the panel surface can be prevented more reliably. Further, the bending rigidity, elasticity, and impact resistance of the foam cement panel are improved and also the pulling resistance of a nail drove into the panel is increased and the workability using the nail is improved.

Similarly to the second foam cement panel 41C, if the outer circumferential side end part of the panel body is coated with the end part protection sheet 46, water absorption from the outer circumferential side end part of the panel body 2 can be prevented and the water-proofness and durability are further improved and at the same time, peeling of the surface reinforcing layer or the surface protection layer 45 from the outer circumferential side end part can be efficiently prevented.

The end part protection sheet 46 can be formed by arbitrary methods comprising sticking a sealing tape having water-tightness; thermally fusion-bonding a film or sheet comprising a synthetic resin material having compatibility with the surface protection layer 45; and carrying out immersion in a synthetic resin material having compatibility with the surface reinforcing layer or the surface protection layer 45; etc.

1.3 Third Foam Cement Panel (Koguchi Type)

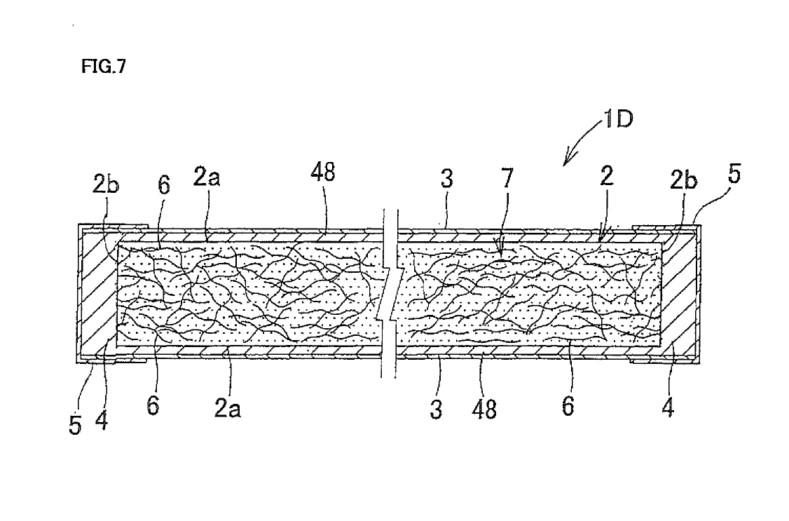

FIG. 7 is a cross-sectional view showing another configuration of a foam cement panel having Koguchi.

A foam cement panel 1D has a side surface reinforcing layer 4 comprising a foamable synthetic resin integrally attached to an outer circumferential side end part 2b of a panel body 2.

In the above-mentioned foam cement panel 1D, both front and back surfaces 2a of the panel body 2 are coated with a surface reinforcing layer 48 comprising a foamable synthetic resin and a surface protection layer 3 is formed on the surface reinforcing layer 48 and further an end part protection sheet 5 covers the outer circumferential side end part of the panel body 2 having these layers.

Respective these materials and production methods are the same as those described above.

The panel body 2 has a side surface reinforcing layer 4 attached to the outer circumferential side end part 2b as outer circumferential four surfaces. The side surface reinforcing layer 4 is so attached a window frame-form as to cover the outer circumferential four surfaces of the panel body 2.

A foamable synthetic resin constituting the side surface reinforcing layer 4 is not particularly limited, and examples thereof include polystyrene foams, polyethylene foams, hard polyurethane foams, soft polyurethane foams, hard vinyl chloride foams, urea foams, phenol foams, acrylic foams, cellulose acetate foams, and other foamable synthetic resins.

As a method of molding the side surface reinforcing layer 4, a conventionally known molding method is applicable. For example, a molding method of the above-mentioned polyurethane foams, urea foams, and phenol foams can be employed.

Although not particularly limited, the foaming magnification at the time of molding the side surface reinforcing layer 4 with a foamable synthetic resin is generally about 2 to 10 times.

As the foaming magnification of the side surface reinforcing layer 4 is smaller, the panel strength is increased more; however, contrarily, the panel weight is increased more. On the other hand, as the foaming magnification of the side surface reinforcing layer 4 is larger, the panel becomes more lightweight; however, contrarily, the panel strength is decreased more.

Accordingly, the foaming magnification of the side surface reinforcing layer 4 is properly determined in terms of the transportability, strength, impact resistance, etc. of the panel.

Further, the thickness of the side surface reinforcing layer 4 is set to be approximately the same as the thickness of the panel body 2 and the width in the direction at right angles to the thickness is not particularly limited; however, it is preferable to set the width to be about 2 to 10 mm so as to efficiently absorb the impact at the time of falling of the panel body 2.

A method of attaching the side surface reinforcing layer 4 to the outer circumferential side end part 2b of the panel body 2 is not also particularly limited, and one example thereof is such that the side surface reinforcing layer 4 can be formed in the outer circumferential side end part 2b of the panel body 2 by foaming and curing a foamable synthetic resin filled in the circumference of the panel body 2 in a tightly closable molding die.

More specifically, first, the panel body 2 is positioned in the center part of a molding die having an inner space slightly larger than the panel body 2; next, a foamable synthetic resin is filled in the circumferential side of the panel body 2, and successively, in the state where the molding die is closed, the filled foamable synthetic resin is foamed and cured to form the side surface reinforcing layer 4 on the outer circumferential side end part 2b of the panel body 2.

As described above, the side surface reinforcing layer 4 is provided by foaming and curing the foamable synthetic resin in the tightly closed molding die so that the side surface reinforcing layer 4 is formed to have a smooth surface covered with a foam-free skin layer in the surface.

In addition, the side surface reinforcing layer 4 is preferable to have few open cells or have closed cells without any open cells. It is because, it is excellent in water-proofness and surface property and in the case where the panel is used for formwork for concrete, it is excellent in releasability from the cast concrete.

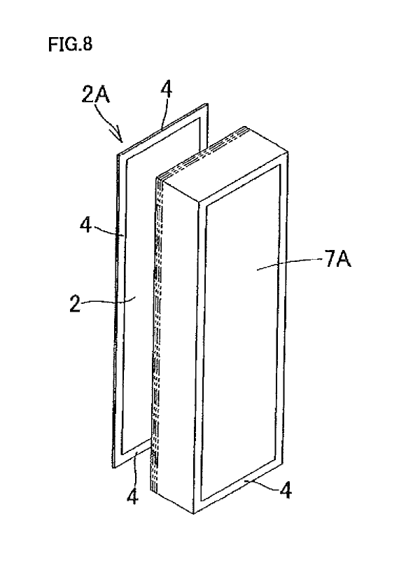

Further, as shown in FIG. 8, a foam cement panel 2A having the side surface reinforcing layer 4 previously formed on the outer circumferential side end part of the panel body 2 may be used.

A specific method for producing such a foam cement panel 2A includes positioning the blockish porous molded body 7A in the center of a molding die having an inner space larger than the porous molded body 7A; filling a foamable synthetic resin in a gap between the porous molded body 7A and the molding die; foaming and curing the foamable synthetic resin to attach the side surface reinforcing layer 4 to the outer circumferential side end part of the porous molded body 7A, as shown in FIG. 8.

The foam cement panel with the side surface reinforcing layer 4 is sliced into a plate-form with a desired thickness and size.

It is sufficient that the side surface reinforcing layer 4 is provided at least on the circumferential four surfaces of the porous molded body 7A and thus the slicing is carried out by a cutting apparatus such as a round saw or a band saw in a manner that the side surface reinforcing layer 4 remains in the circumferential side end part of the foam cement panel 2A.

The thickness of the surface reinforcing layer 48 is set to be about 0.5 to 2 mm. In addition, in the example shown in FIG. 7, the surface reinforcing layer 48 is provided on both front and back surfaces of the foam cement panel 2; however it may be provided only on the surface to which a plate-form stone material is joined.

The synthetic resin constituting the surface reinforcing layer 48 is not particularly limited and resins which are the same as those exemplified for the surface reinforcing layer 42A shown in FIG. 4 may be used.

The synthetic resin of the surface reinforcing layer 48 and the side surface reinforcing layer 4 attached to the outer circumferential side end part of the panel body 2 may be constituted using different type materials; however, it is preferable to constitute them using a single material by simultaneous molding or in separate processes.

In the case where the synthetic resin of the surface reinforcing layer 48 and the side surface reinforcing layer 4 are molded simultaneously, for example, a foamable synthetic resin is filled in the circumference of the panel body 2 positioned in a tightly closable molding die and foamed and cured to cover both front and back surfaces 2a and the outer circumferential side end part 2b of the panel body 2 with the surface reinforcing layer 48 and attach the side surface reinforcing layer 4.

More specifically, first, the bottom part of a molding die having an inner space slightly larger than the panel body 2 is filled with a foamable synthetic resin and at the same time, a surface reinforcing cloth is embedded in the foamable synthetic resin.

Next, the panel body 2 is positioned in the center of the molding die.

Successively, the foamable synthetic resin is filled in the outer circumferential side and upper surface side of the panel body 2 to wrap the panel body 2 with the foamable synthetic resin.

Successively, a surface reinforcing cloth is embedded in the foamable synthetic resin in the upper surface side of the panel body 2.

In the state where the molding die is closed, the filled foamable synthetic resin is foamed and cured to coat the panel body 2 with the surface reinforcing layer 48 and at the same time, to attach the side surface reinforcing layer 4.

As described above, the surface reinforcing layer 48 and the side surface reinforcing layer 4 are provided by foaming and curing the foamable synthetic resin in the tightly closed molding die so that the surface reinforcing layer 48 can be formed to have a smooth surface coated with a foam-free skin layer in the surface and at the same time, cells in the surface of the panel body 2 comprising the porous molded body 7 are closed and thus water absorption from the panel surface can be prevented.

In addition, the surface reinforcing layer 48 and the side surface reinforcing layer 4 having few open cells or closed cells without any open cells are excellent in water-proofness and surface adhesive property.

In the case of formwork usage, it is excellent in releasability from the cast concrete.

Further, in the case where the surface reinforcing layer 48 and the side surface reinforcing layer 4 are molded separately, as described with reference to FIG. 8, the foam cement panel 2A having the side surface reinforcing layer 4 attached to the outer circumferential side end part is produced and the foam cement panel 2A is positioned in the center of a molding die in the state where the bottom part of the molding die is filled with a foamable synthetic resin and next, a foamable synthetic resin is filled on the upper surface side of the foam cement panel 2A and further, in the state where the molding die is tightly closed, the filled foamable synthetic resin is foamed and cured to separately provide the surface reinforcing layer 48 and the side surface reinforcing layer 4 for the panel body 2.

Further, the surface protection layer 3 may be bonded to the surface reinforcing layer 48 by an adhesive; however, at the time of molding the surface reinforcing layer 48, the surface protection layer 3 may be bonded through the foamable synthetic resin when the foamable synthetic resin constituting the surface reinforcing layer 48 is foamed and cured. For example, in the state where the above-mentioned sheet, film, or board to be the surface protection layer 3 is set in the inner surface of the molding die, both front and back surfaces 2a and the outer circumferential side end part 2b of the panel body 2 are coated with the surface reinforcing layer 48 and the side end part reinforcing material 4 is attached by foaming and curing the foamable synthetic resin filled in the surrounding of the panel body 2. Simultaneously, the side surface reinforcing layer 4 can be bonded by using the foamable synthetic resin as an adhesive.

1.4 Fourth Foam Cement Panel (Koguchi Type)

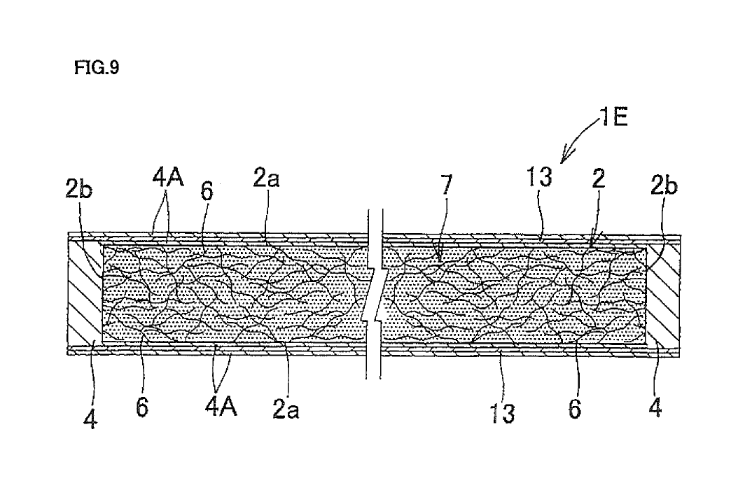

FIG. 9 is a cross-sectional view showing the configuration of a foam cement panel (type of having Koguchi).

A foam cement panel 1E is a panel obtained by omitting the surface protection layer 3 and the end part protection sheet 5 of the above-mentioned foam cement panel 1D and extending a surface reinforcing cloth 13 in the surface reinforcing layer 48 to the side surface reinforcing layer 4 and embedding the cloth in the side surface reinforcing layer 4. The configuration other than those described above is the same as that of the above-mentioned foam cement panel 1D.

In FIG. 9, the same symbols are assigned to the component elements which are the same as those of FIG. 4 and FIG. 7 and their descriptions are omitted.

Further, in FIG. 9, a synthetic resin 4A in the surface reinforcing layer 48, a synthetic resin of the side surface reinforcing layer 4, and the surface reinforcing cloth 13 are drawn in a laminated state, actually, the surface reinforcing cloth 13 is impregnated with the synthetic resins and integrated.

A method for producing the foam cement panel 1E will be described.

First, the bottom part of a molding die which can be tightly closed and has an inner space slightly larger than a panel body 2 is filled with a foamable synthetic resin and at the same time, a surface reinforcing cloth 13 comprising a woven fabric or a nonwoven fabric with approximately the same plane size as the inner plane size of the molding die is embedded in the foamable synthetic resin.

Next, the foam cement panel 2 is positioned in the center of the molding die and then the foamable synthetic resin is filled in the outer circumferential side surface and upper surface side of the foam cement panel 2 and a surface reinforcing cloth 13 comprising a woven fabric or a nonwoven fabric with approximately the same plane size as the inner plane size of the molding die is embedded in the foamable synthetic resin.

Successively, in the state where the molding die is tightly closed, the filled foamable synthetic resin is foamed and cured to attach the side surface reinforcing layer 4 to the outer circumferential side part of the panel body 2 and coat both front and back surfaces of the panel body 2 and side surface reinforcing layer 4 with a surface reinforcing layer (layer in which the surface reinforcing cloth 13 is embedded in the synthetic resin 4A).

Another method for producing the foam cement panel 1E will be described.

Using a molding die which can be closed tightly and has an inner space of a size which is the same as the foam cement panel 1E, a foamable synthetic resin is filled in the bottom part of the molding die and at the same time, a surface reinforcing cloth 13 comprising a woven fabric or a nonwoven fabric with approximately the same plane size as the inner plane size of the molding die is embedded in the foamable synthetic resin.

Next, the above-mentioned foam cement panel 2A (see FIG. 8) having the side surface reinforcing layer 4 in the outer circumferential side end part is positioned in the molding die and thereafter, the foamable synthetic resin is filled in the upper surface side of the foam cement panel 2A and at the same time, a surface reinforcing cloth 13 comprising a woven fabric or a nonwoven fabric with approximately the same plane size as the inner plane size of the molding die is embedded in the foamable synthetic resin.

Next, in the state where the molding die is tightly closed, the filled foamable synthetic resin is foamed and cured to produce the foam cement panel 1E.

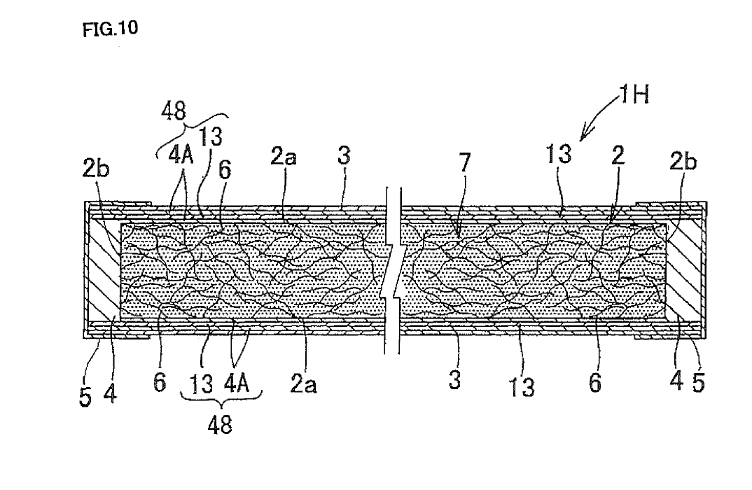

In addition, like a foam cement panel 1H shown in FIG. 10, a surface protection layer 3 and an end part protection sheet 5 may be formed for the above-mentioned foam cement panel 1E (see FIG. 9). In order to produce the foam cement panel 1H described above, in the state where the film, sheet, or board to be the surface protection layer 3 is set in the inner surface of a molding die and also in the same manner as described above, a surface reinforcing layer 48 and a side surface reinforcing layer 4 are provided integrally for the panel body 2 in the molding die, and successively, a sealing tape having water-tightness may be bonded to the outer circumferential side end part of a molded product to form the end part protection sheet 5.

1.5 Fifth Foam Cement Panel (Koguchi Type)

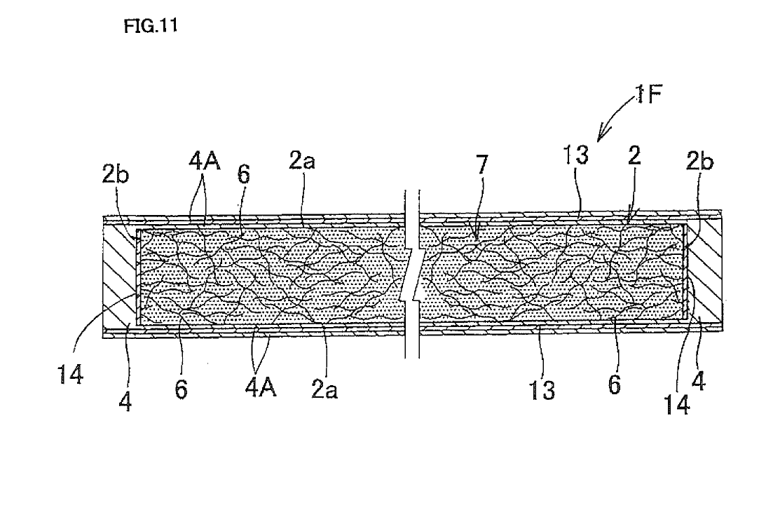

FIG. 11 is a cross-sectional view showing another configuration of a foam cement panel.

A foam cement panel 1F is a panel obtained by embedding a side surface reinforcing cloth 14 comprising a woven fabric or a nonwoven fabric between the outer circumferential side end part 2b of the panel body 2 and the side surface reinforcing layer 4 in the above-mentioned foam cement panel 1E (see FIG. 9) and the configuration other than those described above is the same as that of the above-mentioned foam cement panel 1E.

In FIG. 11, the same symbols are assigned to the component elements which are the same as those of FIG. 9 and their descriptions are omitted.

Examples of the surface reinforcing cloth 14, which is the same as the above-mentioned surface reinforcing cloth, include woven fabrics and nonwoven fabrics comprising fiber materials such as polyvinyl alcohol fibers (Vinylon), polyolefin-based fibers such as polypropylene fibers and polyethylene fibers, aramide fibers, carbon fibers, steel fibers, and glass fibers. Particularly, a chopped strand mat comprising glass fibers which has a weight per unit area of 50 to 1000 g/m², preferably 200 to 300 g/m², is made economically available and capable of significantly improving the strength and rigidity of the foam cement panel 2 and therefore it is preferable.

If the side surface reinforcing cloth 14 is provided in the outer circumferential side end part 2b of the panel body 2 in an embedded manner, the rigidity against the bending and twisting of the foam cement panel 1F can be improved further. In addition, for the above-mentioned foam cement panels shown in FIG. 7 and FIG. 10, the strength and rigidity of the panel against twisting can be improved by providing the side surface reinforcing cloth 14 between the panel body 2 and the side surface reinforcing layer 4 in an embedded manner.

Next, a method for producing the foam cement panel 1F will be described.

First, a panel body 2 is produced in the same manner as the panel body 2 of the foam cement panel 41A, and a belt-like side surface reinforcing cloth 14 is temporarily fixed in an outer circumferential side end part 2b by an adhesive or a temporarily fixing tape.

Next, the inside of a lower part of a molding die having an inner space slightly larger than the panel body 2 is filled with a foamable synthetic resin and at the same time, a surface reinforcing cloth 13 with approximately the same plane size as the inner plane size of the molding die is embedded in the foamable synthetic resin.

Successively, the panel body 2 in which the side surface reinforcing cloth 14 is temporarily fixed is positioned in the center of the molding die and then the foamable synthetic resin is filled in the outer circumferential side surface and upper surface side of the panel body 2 and the foamable synthetic resin is filled so as to wrap the panel body 2 and at the same time, a surface reinforcing cloth 13 is embedded in the foamable synthetic resin in the upper surface side of the panel body 2.

Next, in the state where the molding die is tightly closed, the filled foamable synthetic resin is foamed and cured to produce the foam cement panel 1F.

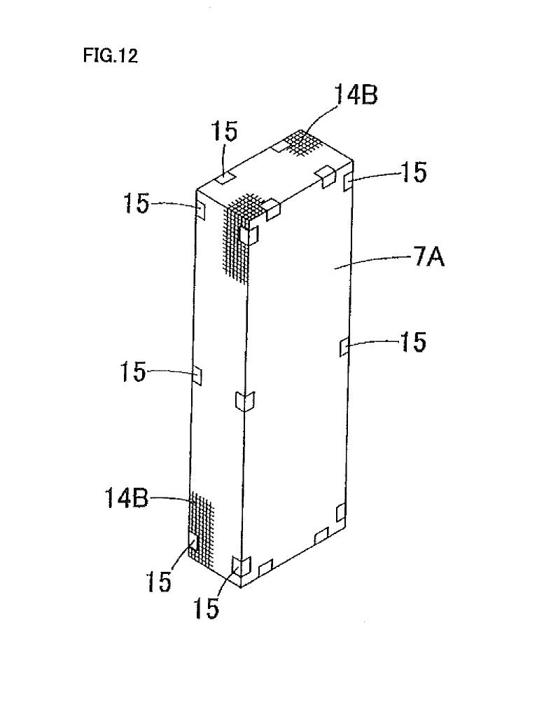

Further, FIG. 12 shows another method for producing a foam cement panel.

In the drawing, blockish porous molded body 7A comprising foam cement is molded and a reinforcing sheet 14B as a material of a side surface reinforcing cloth 14 is temporarily fixed in the outer circumferential side surface of the porous molded body 7 by an adhesive or a temporarily fixing tape 15.

The porous molded body is positioned in the center of a molding die and a foamable synthetic resin is filled in a gap between the porous molded body 7A and the molding die and foamed and cured.

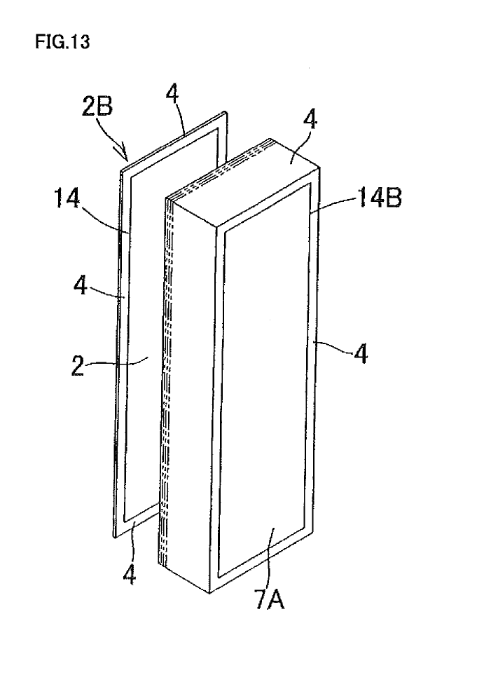

Next, as shown in FIG. 13, a side surface reinforcing layer 4 is attached to the outer circumferential surface of the porous molded body 7A having the reinforcing sheet 14b and the resulting body is sliced in a desired thickness and size to produce a foam cement panel 2B with the side surface reinforcing layer 4 in which the side surface reinforcing cloth 14 is embedded in the outer circumferential end part.

Thereafter, in the same manner as described above, the bottom part of the molding die is filled with a foamable synthetic resin and at the same time, a surface reinforcing cloth 13 is buried in the foamable synthetic resin.

Next, the foam cement panel 2B is placed in the molding die and then, a foamable synthetic resin is filled on the upper surface of the foam cement panel 2B and at the same time, a surface reinforcing cloth 13 is embedded in the foamable synthetic resin.

Next, in the state where the molding die is tightly closed, the filled foamable synthetic resin is foamed and cured to produce the foam cement panel 1F.

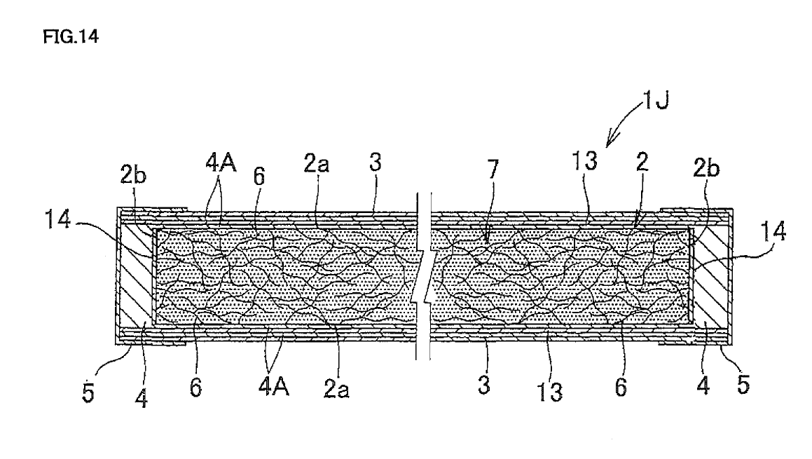

In addition, like a foam cement panel 1J shown in FIG. 14, a surface protection layer 3 and an end part protection sheet 5 may be formed for the above-mentioned foam cement panel 1F (see FIG. 11).

In the case of producing the foam cement panel 1J as described above, in the state where the sheet, film, or board to be the surface protection layer 3 is set in the inner surface of the molding die, the foamable synthetic resin is filled in the bottom part of the molding die and at the same time, the surface reinforcing cloth 13 is embedded in the foamable synthetic resin and then the porous molded body 7 is positioned in the molding die in the same manner as described above.

Next, a foamable synthetic resin is filled on the upper surface side of the porous molded body 7 and at the same time, a surface reinforcing cloth 13 is embedded in the foamable synthetic resin.

Successively, in the state where the molding die is tightly closed, the filled foamable synthetic resin is foamed and cured and finally a sealing tape having water-tightness may be bonded to the outer circumferential side end part to form the end part protection sheet 5.

In addition, in order to increase the installation strength of the side surface reinforcing layer 4 to the panel body 2, it is preferable to provide the end part protection sheet 5 so that at least the boundary part of the panel body 2 and the side surface reinforcing layer 4 is covered with the end part protection sheet 5.

If the end part protection sheet 5 is provided in the side surface reinforcing layer 4 attached to the outer circumferential side end part of the panel body 2, the end part protection sheet 5 can be molded simultaneously with the side surface reinforcing layer 4 and thus increase of the production cost can be suppressed and it is preferable.

Next, the effect of the above-mentioned foam cement panel (Koguchi type) will be described.

In the above-mentioned foam cement panel, the side surface reinforcing layer comprising a foamable synthetic resin is provided in the outer circumferential side end part of the panel body, so-called cut end surface of the panel body, and therefore, even if the foam cement panel drops, the foam cement panel can absorb the impact of dropping and the foam cement panel is prevented from damages such as cracking and breaking.

The above-mentioned foam cement panel is lightweight, high strength and excellent in processibility as well. Further, unlike a woody plywood using wood resource, the foam cement panel uses cement as a main material and therefore, consumption of the wood resource from tropical forests can be saved and it contributes to environmental preservation.

Further, since the foam cement panel includes the panel body comprising a porous molded body in which a large number of cells foamed by a foaming agent are dispersed, a side surface reinforcing layer covering the outer circumferential side end part of the panel body, and the surface protection layer covering the surface of the panel body, and has a specific gravity of 1.0 or lower as light as that of plywood, the foam cement panel is excellent in operatability and processibility and advantageous in that unlike plywood, the panel shows neither increase of weight nor decease of strength due to water absorption.

Further, the above-mentioned panel body has a reinforcing structure owing to intertwining with reinforcing fibers existing in a dispersed state and is so strong as to have a bending elastic modulus of, for example, 1700 N/mm² or higher and also excellent in processibility of nailing or the like and hit nails or the like are stably held by the above-mentioned reinforcing fibers.

In the foam cement panel, the amount of the reinforcing fibers contained in the foam cement constituting the panel body is not particularly limited; however, the reinforcing fibers existing in a dispersed state are intertwined to form the reinforcing structure by blending about 0.5 to 5 parts by mass based on 100 parts by mass of cement.

For example, even in the case where the panel is used for formwork for concrete, sufficient strength to the pressure of the cast concrete can be reliably ensured.

The kinds of the reinforcing fibers are not particularly limited, and examples thereof include Vinylon, that is, polyvinyl alcohol fibers; polyolefin-based fibers such as polypropylene fibers and polyethylene fibers, aramide fibers, carbon fibers, steel fibers, and glass fibers.

The panel body of the present invention may be produced by molding a cement kneaded material into a plate-form with an aimed size, and it may be also produced by molding into a large block-form and slicing it into a plate-form with a desired thickness and size; or by molding into a large block-form, thereafter, coating a foam synthetic resin layer on the outer circumferential side surface thereof, and slicing it into a plate-form with a desired thickness and size.

Further, the panel body of the present invention may also be produced by molding into a large block-form, thereafter, coating a foam synthetic resin layer in the state where a reinforcing sheet to be a side surface reinforcing cloth is temporarily fixed in the outer circumferential side surface thereof, and slicing it into a plate-form with a desired thickness and size.

In the case of molding into a block-form and slicing the block molded panel body into a plate-form, a large number of foam cement panels can be produced by using a single formwork at one time, and curing and solidification can be carried out collectively and thus the productivity is improved.

Further, in the case of molding into a block-form, and then slicing a panel in which the outer circumferential surface is coated with the foamable synthetic resin, the productivity is further improved and at the same time, the foam synthetic resin layer can be formed previously on the side end surface of the panel body so that the positioning work of the panel body in the molding die for a product can be easy.

Since the surface reinforcing layer is provided on the surface of the panel body, water absorption from the panel surface can be prevented by the surface reinforcing layer and the water-proofness of the foam cement panel can be improved. Further, the surface reinforcing layer makes it possible to improve the impact resistance of the foam cement panel surface, and to effectively prevent damages from being generated on the foam cement panel surface.

Moreover, the strength and rigidity against bending and twisting of the foam cement panel can be improved further by providing the side surface reinforcing cloth comprising a woven fabric or a nonwoven fabric between the circumferential side surface of the panel body and the side surface reinforcing layer. An increase in the production cost can be suppressed and at the same time, the strength and rigidity against bending and twisting can be improved by using a nonwoven fabric made of glass fibers which has a weight per unit area of 50 to 1000 g/m² as the surface reinforcing cloth or the side surface reinforcing cloth.

If the surface of the panel body is coated with the surface reinforcing layer, water absorption from the panel surface can be prevented further by the surface protection layer and thus the water-proofness of the foam cement panel can be improved. Furthermore, the surface protection layer can include a non-foamable synthetic resin. If the surface protection layer includes a non-foamed synthetic resin, water absorption from the panel surface can be more reliably prevented.

Further, if the outer circumferential side end part of the panel body is coated integrally with the end part protection sheet, water absorption from the surface reinforcing layer or the outer circumferential side end part of the panel body can be prevented and the water-proofness and durability can be further improved and at the same time, peeling of the surface reinforcing layer or the surface protection layer from the outer circumferential side end part can be efficiently prevented.

The above-mentioned end part protection sheet can be formed by an arbitrary method; by bonding a sealing tape having water-tightness; by thermally bonding a film or sheet comprising a synthetic resin material having compatibility with the surface protection layer; by carrying out immersion in a synthetic resin material having compatibility with the surface protection layer; etc.

2. Configuration of Panel with Decorative Slate

Next, the panel with decorative slate of the present invention will be described.

2.1 First Panel with Decorative Slate

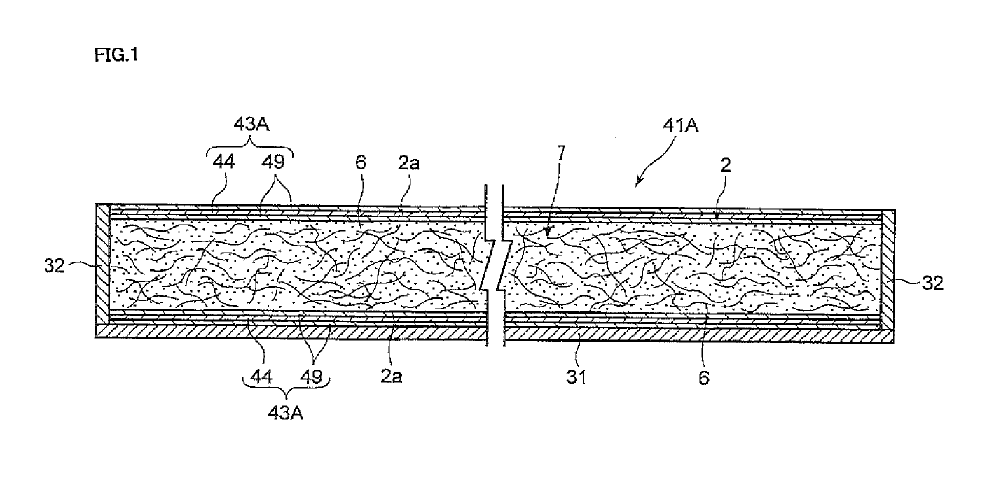

FIG. 1 is a cross-sectional view showing the first panel with decorative slate of the present invention.

The panel with decorative slate shown in the drawing is produced by using the foam cement panel 41A shown in FIG. 4.

The first panel with decorative slate is obtained by using the foam cement panel 41A as a substrate of a panel with decorative slate, bonding a plate-form stone material (a plate-form stone material 31 for surface) to the surface of the foam cement panel 41A by an adhesive, and also bonding a plate-form stone material (a plate-form stone material 32 for side surface) to the outer circumferential side surface of the foam cement panel 41A by an adhesive.

According to the description regarding the adhesive property of the surface reinforcing layer 43A of the foam cement panel 41A and the plate-form stone material 31 for surface, since the surface reinforcing layer is obtained by embedding a fiber aggregate in a synthetic resin, considerably many fine projections and recessions are formed in the surface and these projections and recessions increase the adhesion surface area and therefore, they exert an anchor effect for obtaining good adhesion.

Since the surface reinforcing layer 43A of the foam cement panel 41A is directly bonded to the entire back surface of the plate-form stone material 31 for surface as described above, even if water is infiltrated to the panel body 2 of the foam cement panel 41A, the surface reinforcing layer 43A serves as a water-proofing layer and water in the panel body 2 is prevented from transferring to the plate-form stone material 31 for surface.

Accordingly, water adhesion and infiltration from the back surface of the plate-form stone material 31 for surface can be prevented. Consequently, generation of stains on the surface of the plate-form stone material 31 for surface can be prevented.

In the first panel with decorative slate, since the specific gravity of the foam cement panel 41A is low, the panel with decorative slate, which is obtained by joining the plate-form stone materials 31 and 32 to the foam cement panel 41A, becomes lightweight as a whole.

Further, the panel body includes mainly foam cement and is provided with improved strength owing to the surface reinforcing layer 43A. In addition, since the plate-form stone material 31 for surface and the plate-form stone material 32 for side surface serve as a reinforcing layer, the strength of the panel with decorative slate is increased as a whole.

Various kinds of stone materials can be used as the plate-form stone material 31 for surface and the plate-form stone material 32 for side surface and examples thereof include Mikageishi such as granite, diorite, and gabbro, and also marble. Any of these stone materials is cut into a thin plate-form to obtain the plate-form stone material 31 for surface and plate-form stone material 32 for side surface.

In addition, a method of bonding the panel body to both surfaces of the stone material and thereafter cutting and dividing the stone material may also be employed.

2.2 Second Panel with Decorative Slate

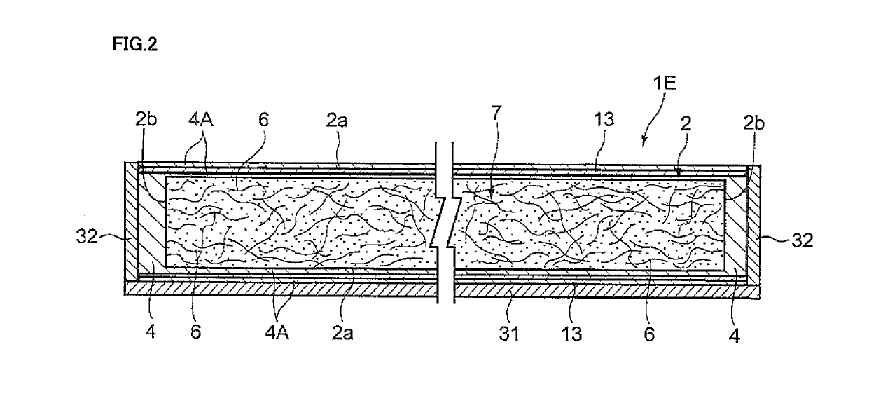

FIG. 2 is a cross-sectional view showing the second panel with decorative slate of the present invention.

The panel with decorative slate shown in the drawing is produced by using the foam cement panel 1E shown in FIG. 9.

The second panel with decorative slate is obtained by bonding a plate-form stone material (a plate-form stone material 31 for surface) to the surface of the foam cement panel 1E by an adhesive and also bonding a plate-form stone material (a plate-form stone material 32 for side surface) to the outer circumferential side surface of the foam cement panel 1E by an adhesive.

Since the foam cement panel 1E is provided with the surface reinforcing layer on the front and back surfaces of the panel body 2 (layer in which the surface reinforcing cloth 13 is embedded in the synthetic resin 4A), owing to the water-proofness of the surface reinforcing layer, water adhesion to and water infiltration from the back surface of the plate-form stone material 31 for surface are prevented. Further, the adhesive property of the surface reinforcing layer of the foam cement panel 1E and the plate-form stone material 31 for surface is excellent.

In addition, since the foam cement panel 1E has the side surface reinforcing layer 4 in the outer circumferential side surface 2b of the panel body 2, the side surface reinforcing layer 4 also serves as a water-proofing layer and water adhesion to and water infiltration from the back surface of the plate-form stone material 32 for side surface are prevented.

More specifically, in the panel body 2, the front and back surfaces are coated with the surface reinforcing layer (layer in which the surface reinforcing cloth 13 is embedded in the synthetic resin 4A) and the side surface reinforcing layer 4 is attached to the outer circumferential surface and therefore, the entire surface of the panel body 2 is coated.

Since the surface reinforcing layer and the side surface reinforcing layer 4 serve as water-proofing layers, the outside water is hardly infiltrated to the panel body 2 itself. Accordingly, with respect to the plate-form stone material 31 for surface and plate-form stone material 32 for side surface joined thereto, there is little fear of water adhesion to and water infiltration from the back surfaces thereof.

2.3 Third Panel with Decorative Slate

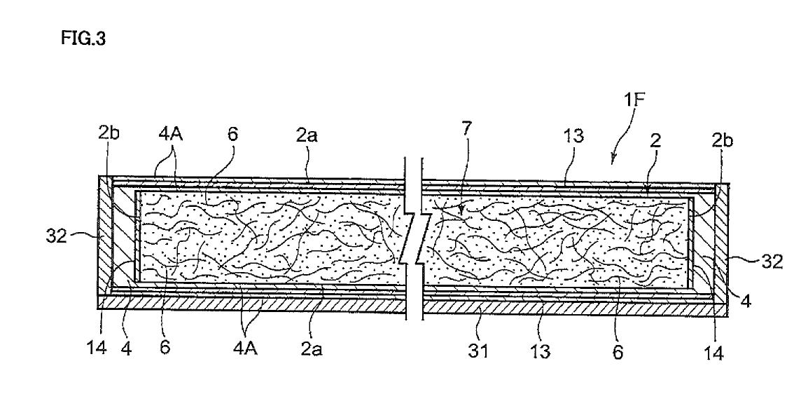

FIG. 3 is a cross-sectional view showing the third panel with decorative slate of the present invention.

The panel with decorative slate shown in the drawing is produced by using the foam cement panel 1F shown in FIG. 11.

The third panel with decorative slate is obtained by bonding a plate-form stone material (a plate-form stone material 31 for surface) to the surface of the foam cement panel 1F by an adhesive and also bonding a plate-form stone material (a plate-form stone material 32 for side surface) to the outer circumferential side surface of the foam cement panel 1F by an adhesive.

Also in the third panel with decorative slate, there is little fear of water adhesion to and water infiltration from the back surfaces of the plate-form stone material 31 for surface and the plate-form stone material 32 for side surface.

Further, the adhesive property of the surface reinforcing layer (layer in which the surface reinforcing cloth 13 is embedded in the synthetic resin 4A) of the foam cement panel 1F and the plate-form stone material 31 for surface is excellent.

3. Method for Producing Panel with Decorative Slate

3.1 Production of Foam Cement Panel Comprising Porous Molded Body

Cement milk was obtained by adding and mixing 30 to 40 parts by mass of water and 0.2 to 1.0 part by mass of a commercialized water reducing agent based on 100 parts by mass of rapid-hardening Portland cement, adding short fibers of Vinylon in an amount of 0.2 to 2.0 parts by mass based on 100 parts by mass of the rapid-hardening Portland cement, and kneading the resulting mixture.

On the other hand, air is added to a commercialized foaming agent and stirred and mixed to carry out pre-foaming at about 10 to 30 times magnification.

The foams pre-foamed were added to the above-mentioned cement milk in an amount of 4 to 8 parts by mass based on 100 parts by mass of the rapid-hardening Portland cement and kneaded to obtain a kneaded cement material.

The kneaded cement material was filled in a pressure-resistant metal formwork having a size of length 1780 mm×width 580 mm×height 300 mm and steam cured for 3 to 18 hours in a tightly closed state.

Successively, a blockish molded body was obtained by any of the following methods.

a) Carrying out steam curing further for 8 to 24 hours after form removal. b) Carrying out steam curing and successively carrying out curing at room temperature. c) Without steam curing, carrying out curing at room temperature. d) Carrying out neither steam curing nor curing at room temperature.

A blockish molded body obtained in the above-mentioned manner was sliced into a plate-form with thickness of 11 mm to produce a panel body comprising a porous molded body.

The specific gravity of each sample of the obtained panel main bodies was in a range of 0.55 to 0.85; bending strength in a range of 1.7 to 3.5 N/mm²; and bending elastic modulus in a range of 1400 to 3000 N/mm².

In this connection, the specific gravity was calculated from the size (width×length×thickness) and mass of each sample. The bending strength and bending elastic modulus were measured according to JIS A 1408 while the distance L (span) of the support for supporting each sample at two points being set to be 250 mm.

For the production of panel main bodies and joining to plate-form stone materials, four panel main bodies (referred to as panel main bodies A to D) were selected among the obtained main bodies to produce samples. The production conditions of these panel main bodies A to D are shown in Table 1 below.

TABLE 1

| | | A | B | C | D |
|---|---|---|---|---|---|
| panel body | rapid-hardening Portland cement (parts by mass) | 100 | 100 | 100 | 100 |
| | water (parts by mass) | 32.2 | 31.0 | 35.0 | 33.1 |
| | water reducing agent (parts by mass) | 0.30 | 0.30 | 0.31 | 0.47 |
| | short fibers (parts by mass) | 1.19 | 0.58 | 1.29 | 0.59 |
| | foaming agent (parts by mass) | 6.20 | 5.73 | 6.13 | 5.73 |
| | steam curing period in the molding die (hour) | 4 | 18 | 6 | 4 |
| | steam curing period after demolding (hour) | 12 | — | 12 | 12 |
| | curing period at room temperatue in the outside (day) | — | 7 | 3 | — |

3.2 Method for Producing Foam Cement Panel (Koguchi-Free Type)

As a pressure-resistant molding die, one having an inner space of a size slightly larger in length, width, and height than the above-mentioned cement panel, and capable of being closed tightly is used.

A foamable urethane resin was filled in a gap between the inner surface of the pressure-resistant molding die and the panel body and at the same time, a chopped strand mat comprising glass fibers which has a weight per unit area of 100 to 900 g/m² as a surface reinforcing cloth was embedded in the foamable urethane resin.

In the above-mentioned manner, the surface reinforcing cloth was impregnated with the foamable urethane resin to form a surface reinforcing layer, and both front and back surfaces of the panel body were coated with the surface reinforcing layer to obtain a foam cement panel (Koguchi-free type).

3.3 Joining of Plate-Form Stone Material and Foam Cement Panel

As a plate-form stone material (a plate-form stone material 32 for side surface) to coat the outer circumferential side surface of the panel body, marble with a size of length 1800 mm×width 15 mm×thickness 3 mm and marble with a size of length 600 mm×width 15 mm×thickness 3 mm were prepared (provided that, the vertical length was cut corresponding to the butting point of the marbles), and as a plate-form stone material (a plate-form stone material 31 for surface) to coat the one side surface of the panel body, marble with a size of length 1800 mm×width 600 mm×thickness 3 mm was prepared.

The marble plates were bonded to the surface and circumferential side surface of the panel body by an adhesive to obtain a panel with decorative slate as shown in FIG. 1 (completed trial product samples No. 1 to 4).

The respective conditions and characteristics of each panel with decorative slate are collectively described in Table 2. In addition, as the plate-form stone material for surface coating, one with a thickness of two times was prepared and the panel body was bonded to both sides, and the plate-form stone material was then sliced at the middle in depthwise direction of that to produce similarly completed trial product samples.

TABLE 2

| | completed trial product sample No. | | | | No. 1 | No. 2 | No. 3 | No. 4 |
|---|---|---|---|---|---|---|---|---|
| panel with | foam cement | panel body | | | A | B | C | D |
| decorative | panel (Koguchi- | surface reinforcing | surface reinforcing cloth(fiber aggregate) * | (g/m²) | 125 | 200 | 230 | 300 |
| slate | free type) | layer (mat type) | synthetic resin | (g/m²) | 150 | 200 | 250 | 300 |

| | | | | |
|---|---|---|---|---|
| water proofness | good | good | good | good |

| | | | | | |
|---|---|---|---|---|---|
| bending strength | (N/mm²) | 9.61 | 10.96 | 13.84 | 16.16 |
| specific gravity | (g/cm³) | 1.03 | 1.04 | 1.03 | 1.04 |
| adhesive property of foam cement panel and plate-form stone | (N/mm²) | 0.37 | 0.40 | 0.50 | 0.42 |

(n = 3)
* weight per unit area

It was confirmed that even though the panels with decorative slate (samples No. 1 to 4) obtained in the above-mentioned manner were provided with decorativeness which was possessed by marble, they were lightweight, and moreover no stain was generated in the marble surface for a long period of time. The marble (plate-form stone material) was well bonded to the panel body.

Test method of water-proofness of each foam cement panel was carried out by dripping colored water on the upper surface of a sample for 24 hours and thereafter, observing the cross section of the panel. If coloring was observed in the panel, water infiltration was caused and therefore, water-proofness was inferior and if no coloring was observed, the water-proofness was determined to be good.

The specific gravity of each panel with decorative slate was calculated from the size (width×length×thickness) and mass of each sample. The bending strength was measured according to JIS A1408 while the distance L (span) of the supporting body for supporting each sample at two points being set to be 250 mm.

The adhesion strength of the panel body and the plate-form stone material was measured according to a tile tensile test.

The size of a test jig was made to be 45 mm×95 mm and the test jig and a plate-form stone material were firmly fixed and after the edge of the panel body and the plate-form stone material was cut along the test jig, the test was carried out (number of samples n=3).

4. Another Method for Producing Panel with Decorative Slate

4.1 Each Foam Cement Panel was Produced in the Same Method as in the Method for Producing the Foam Cement Panel in the First Panel with Decorative Slate as Described Above.

4.2 Method for Producing Foam Cement Panel (Koguchi Type)

As a pressure-resistant molding die, one having an inner space of a size slightly larger in length, width, and height than the above-mentioned cement panel, and capable of being closed tightly is used.

A foamable urethane resin was sprayed to the bottom of the above-mentioned pressure-resistant molding die and at the same time, a nonwoven fabric sheet (surface reinforcing cloth) comprising glass fibers with the almost same plane size as the panel body was embedded in the foamable urethane resin.

Successively, the panel body in which a belt-like nonwoven sheet (side surface reinforcing cloth) comprising glass fibers was temporarily fixed in the outer circumferential side surface was positioned in the center of the molding die.

Next, the foamable urethane resin was filled in a gap between the panel body and the inner side surface of the molding die.

Successively, the foamable urethane resin was sprayed to the upper part of the panel body and at the same time, a nonwoven fabric sheet (surface reinforcing cloth) comprising glass fibers with the almost same plane size as the panel body was embedded in the foamable urethane resin, and foaming and curing was carried out in the closed molding die.

Consequently, a panel body having Koguchi as shown in FIG. 11 (length 1794 mm×width 594 mm×thickness 15 mm) was obtained.

Additionally, the layer formed on both front and back surfaces of the panel body, in which the nonwoven fabric sheet was embedded in the foamable polyurethane resin, became the surface reinforcing layer.

Also, the foamable urethane resin (foamable urethane resin filled in the gap between the panel body and the inner surface of the molding die) formed in the outer circumferential side surface of the panel body became the side surface reinforcing layer.

4.3 Joining of Plate-Form Stone Material and Panel Body

In the same bonding method of plate-form stone materials as that in the above-mentioned first panel with decorative slate, plate-form marble (plate-form stone material) was bonded to the panel body to obtain a panel with decorative slate (completed trial product samples No. 5 to 8).

The respective conditions and characteristics of each panel with decorative slate are as described in Table 3 below. The respective test methods are the same as described above.

TABLE 3

| | completed trial product sample No. | | | | No. 5 | No. 6 | No. 7 | No. 8 |
|---|---|---|---|---|---|---|---|---|
| panel with | foam cement | panel body | | | A | B | C | D |
| decorative | panel (Koguchi | surface reinforcing | surface reinforcing cloth(fiber aggregate) * | (g/m²) | 125 | 200 | 230 | 300 |
| slate | type) | layer (mat type) | synthetic resin | (g/m²) | 150 | 200 | 250 | 300 |
| | | side part reinforcing layer | synthetic resin ** | (g/cm³) | 0.33 | 0.33 | 0.33 | 0.33 |

| | | | | |
|---|---|---|---|---|
| water proofness | good | good | good | good |

| | | | | | |
|---|---|---|---|---|---|
| bending strength | (N/mm²) | 10.1 | 11.2 | 13.2 | 15.8 |
| specific gravity | (g/cm³) | 1.04 | 1.04 | 1.03 | 1.04 |
| adhesive property of foam cement panel and plate-form stone | (N/mm²) | 0.37 | 0.40 | 0.51 | 0.43 |

(n = 3)
* weight per unit area
** apparent specific gravity

It was confirmed that it was the same as the first panel with decorative slate, even though the panels with decorative slate (samples No. 5 to 8) were also provided with decorativeness which was possessed by marble, they were lightweight, and moreover no stain was generated in the marble surface for a long period of time. The marble (plate-form stone material) was well bonded to the panel body.

5. Still Another Method for Producing Panel with Decorative Slate

5.1 Each Foam Cement Panel was Produced in the Same Method as in the Method for Producing the Foam Cement Panel in the First Panel with Decorative Slate as Described Above.

5.2 Method for Producing Foam Cement Panel (Koguchi-Free Type)

A pressure-resistant molding die having an inner space of a size slightly larger in length, width, and height than the above-mentioned cement panel was used, and a foamable urethane resin was sprayed to the bottom surface of the pressure-resistant molding die and successively, glass short fibers were scattered on the resin and the glass short fibers were embedded in the foamable urethane resin.

In this case, the amount of glass short fibers scattered was 100 to 900 g/m².

In the above-mentioned manner, a foam cement panel in which the front and back surfaces of the panel body were coated with the surface reinforcing layer was obtained.

5.3 Joining of Plate-Form Stone Material and Foam Cement Panel

In the same bonding method of plate-form stone materials as that in the above-mentioned first panel with decorative slate, plate-form marble (plate-form stone material) was bonded to the foam cement panel to obtain a panel with decorative slate (completed trial product samples No. 9 to 12). The respective conditions and characteristics of each panel with decorative slate are as described in Table 4 below. The respective test methods are same as described above.

TABLE 4

| | completed trial product sample No. | | | | No. 9 | No. 10 | No. 11 | No. 12 |
|---|---|---|---|---|---|---|---|---|
| panel with | foam cement | panel body | | | A | B | C | D |
| decorative | panel (Koguchi- | surface reinforcing | sprayed fiber level (fiber aggregate) | (g/m²) | 125 | 200 | 230 | 300 |
| slate | free type) | layer (GF spray type) | synthetic resin | (g/m²) | 150 | 200 | 250 | 300 |

| | | | | |
|---|---|---|---|---|
| water proofness | good | good | good | good |

| | | | | | |
|---|---|---|---|---|---|
| bending strength | (N/mm²) | 9.5 | 11.8 | 14.5 | 17.0 |
| specific gravity | (g/cm³) | 1.04 | 1.04 | 1.03 | 1.04 |
| adhesive property of foam cement panel and plate-form stone | (N/mm²) | 0.37 | 0.41 | 0.50 | 0.42 |

(n = 3)

It was confirmed that it was the same as the first panel with decorative slate, even though the panels with decorative slate (samples No. 9 to 12) were also provided with decorativeness which was possessed by marble, they were lightweight, and moreover no stain was generated in the marble surface for a long period of time. The marble (plate-form stone material) was well bonded to the panel body.

### INDUSTRIAL APPLICABILITY

The present invention can be employed for exterior walls, or interior walls, or floor materials of various kinds of buildings and constructions.

1. A panel with decorative slate having a foam cement panel joined to the entire back side surface of a plate-form stone material, wherein
the foam cement panel is constituted by a laminated structure of a porous panel body comprising foam cement and a surface reinforcing layer coated on the surface of the panel body,
the panel body contains reinforcing fibers in the foam cement in a dispersed state, and
the surface reinforcing layer has a synthetic resin layer containing a fiber aggregate embedded therein and disposed at least between the plate-form stone material and the panel body.

2. The panel with decorative slate according to claim 1, wherein the surface reinforcing layer is provided on both front and back surfaces of the panel body.

3. The panel with decorative slate according to claim 1, wherein a synthetic resin molded body containing a fiber aggregate embedded therein or a side surface reinforcing layer comprising a thickly applied sealer is attached to the outer circumferential side surface of the panel body.

4. The panel with decorative slate according to claim 3, wherein a plate-form stone material is joined to the outer circumferential side surface of the foam cement panel and the side surface reinforcing layer is provided between the plate-form stone material and the outer circumferential side surface of the panel body.

5. The panel with decorative slate according to claim 1, wherein the synthetic resin constituting the surface reinforcing layer is a foamable synthetic resin.

6. The panel with decorative slate according to claim 2, wherein a synthetic resin molded body containing a fiber aggregate embedded therein or a side surface reinforcing layer comprising a thickly applied sealer is attached to the outer circumferential side surface of the panel body.

7. The panel with decorative slate according to claim 6, wherein a plate-form stone material is joined to the outer circumferential side surface of the foam cement panel and the side surface reinforcing layer is provided between the plate-form stone material and the outer circumferential side surface of the panel body.

8. The panel with decorative slate according to claim 2, wherein the synthetic resin constituting the surface reinforcing layer is a foamable synthetic resin.
